(19) United States
(12) Patent Application Publication
(10) Pub. No.: US 2025/0214801 A1
(43) Pub. Date: Jul. 3, 2025

(54) SHEET PROCESSING APPARATUS, SHEET ACCOMMODATING APPARATUS, AND IMAGE FORMING SYSTEM

(71) Applicant: CANON FINETECH NISCA INC., Saitama (JP)

(72) Inventors: Taiki Akiyama, Chiba (JP); Shinnosuke Enomoto, Yamanashi (JP); Shoubu Kato, Yamanashi (JP); Hiroki Komada, Yamanashi (JP); Akito Yoda, Yamanashi (JP); Satoshi Horiguchi, Yamanashi (JP)

(21) Appl. No.: 18/979,837

(22) Filed: Dec. 13, 2024

(30) Foreign Application Priority Data
Dec. 28, 2023 (JP) 2023-222470
Sep. 30, 2024 (JP) 2024-171115

(51) Int. Cl. B65H 45/30; G03G 15/00

(52) U.S. Cl. CPC B65H 45/30; G03G 15/6544; G03G 15/6582; B65H 2301/45; B65H 2301/5161; B65H 2402/32; B65H 2402/42; B65H 2402/60; B65H 2801/27; G03G 2215/00936

(57) ABSTRACT

A sheet processing apparatus includes a plurality of casters, a processing unit, another caster and a support portion. The plurality of casters movably support the sheet processing apparatus. The processing unit is provided to be capable of being drawn out from and inserted into the sheet processing apparatus. The other caster is provided in the processing unit and comes into contact with an installation surface and supports the processing unit in a case where the processing unit moves in a draw-out direction. The support portion supports the other caster such that the other caster is movable to an accommodation position and a support position and move the other caster from the support position to the accommodation position in accordance with an operation of inserting the processing unit.

### BACKGROUND OF THE INVENTION

### Field of the Invention

The present invention relates to a sheet processing apparatus that performs a predetermined process on a sheet, a sheet accommodating apparatus that accommodates a sheet, an image forming system including the sheet processing apparatus, and an image forming system including the sheet accommodating apparatus.

### Description of the Related Art

Conventionally, a configuration in which a processing unit or a sheet accommodation portion can be drawn out from the apparatus for addressing a sheet jam having occurred in a processing unit or for replenishing an accommodation unit with a sheet is known for sheet processing apparatuses, sheet accommodating apparatuses, and the like.

A configuration which includes a caster and in which, in the case of drawing out a draw-out unit that can be drawn out such as a processing unit or an accommodation unit from an apparatus as described above, the caster supports the draw-out unit during the draw-out operation by rotating in contact with an installation surface to assist the draw-out operation is proposed (Japanese Paten Application Laid-Open No. 2014-19533).

Here, in a sheet processing apparatus or a sheet accommodating apparatus including a draw-out unit, a caster for moving the entire apparatus is provided in addition to a caster provided on the draw-out unit for assisting the draw-out operation of the draw-out unit. Therefore, in the case where, for example, an installation surface such as the floor is uneven, there is a possibility that the caster provided on the draw-out unit for assisting the draw-out operation abuts the uneven portion of the floor surface or the like when moving the entirety of the apparatus such as a sheet processing apparatus or a sheet accommodating apparatus. There is a possibility that as a result of this, movement of the apparatus itself using the caster for moving the entire apparatus is interrupted and the useability is degraded.

### SUMMARY OF THE INVENTION

The present invention provides a configuration in which deterioration of usability can be suppressed without interrupting the movement of an apparatus itself in a configuration including a caster assisting a draw-out operation of drawing out a unit from the apparatus.

According to a first aspect of the present invention, a sheet processing apparatus includes a plurality of casters configured to movably support the sheet processing apparatus, a processing unit provided to be capable of being drawn out from and inserted into the sheet processing apparatus and configured to perform a predetermined process on a sheet, another caster provided in the processing unit and configured to come into contact with an installation surface and support the processing unit in a case where the processing unit moves in a draw-out direction, the installation surface being a surface on which the sheet processing apparatus is installed, and, a support portion configured to support the other caster such that the other caster is movable to an accommodation position and a support position and move the other caster from the support position to the accommodation position in accordance with an operation of inserting the processing unit, the accommodation position being a position where the other caster is positioned in a state in which the processing unit is inserted in the sheet processing apparatus, the support position being a position where the other caster supports the processing unit drawn out from the sheet processing apparatus with respect to the installation surface.

According to a second aspect of the present invention, an image forming system includes an image forming unit including an image forming portion configured to form an image on a sheet, and, a sheet processing apparatus configured to perform a predetermined process on the sheet on which the image has been formed by the image forming portion. The sheet processing apparatus includes a plurality of casters configured to movably support the sheet processing apparatus, a processing unit provided to be capable of being drawn out from and inserted into the sheet processing apparatus and configured to perform the predetermined process on the sheet, another caster provided in the processing unit and configured to come into contact with an installation surface and support the processing unit in a case where the processing unit moves in a draw-out direction, the installation surface being a surface on which the sheet processing apparatus is installed, and, a support portion configured to support the other caster such that the other caster is movable to an accommodation position and a support position and move the other caster from the support position to the accommodation position in accordance with an operation of inserting the processing unit, the accommodation position being a position where the other caster is positioned in a state in which the processing unit is inserted in the sheet processing apparatus, the support position being a position where the other caster supports the processing unit drawn out from the sheet processing apparatus with respect to the installation surface.

According to a third aspect of the present invention, a sheet accommodating apparatus includes a plurality of casters configured to movably support the sheet accommodating apparatus, an accommodation unit provided to be capable of being drawn out from and inserted into the sheet accommodating apparatus and configured to accommodate a sheet, another caster provided in the accommodation unit and configured to come into contact with an installation surface and support the accommodation unit in a case where the accommodation unit moves in a draw-out direction, the installation surface being a surface on which the sheet accommodating apparatus is installed, and, a support portion configured to support the other caster such that the other caster is movable to an accommodation position and a support position and move the other caster from the support position to the accommodation position in accordance with an operation of inserting the accommodation unit, the accommodation position being a position where the other caster is positioned in a state in which the accommodation unit is inserted in the sheet accommodating apparatus, the support position being a position where the other caster supports the accommodation unit drawn out from the sheet accommodating apparatus with respect to the installation surface.

According to a fourth aspect of the present invention, an image forming system includes a sheet accommodating apparatus configured to accommodate a sheet, and, an image forming unit including an image forming portion configured to form an image on the sheet fed by the sheet accommodating apparatus. The sheet accommodating apparatus includes a plurality of casters configured to movably support the sheet accommodating apparatus, an accommodation unit provided to be capable of being drawn out from and inserted into the sheet accommodating apparatus and configured to accommodate the sheet, another caster provided in the accommodation unit and configured to come into contact with an installation surface and support the accommodation unit in a case where the accommodation unit moves in a draw-out direction, the installation surface being a surface on which the sheet accommodating apparatus is installed, and, a support portion configured to support the other caster such that the other caster is movable to an accommodation position and a support position and move the other caster from the support position to the accommodation position in accordance with an operation of inserting the accommodation unit, the accommodation position being a position where the other caster is positioned in a state in which the accommodation unit is inserted in the sheet accommodating apparatus, the support position being a position where the other caster supports the accommodation unit drawn out from the sheet accommodating apparatus with respect to the installation surface.

Further features of the present invention will become apparent from the following description of exemplary embodiments with reference to the attached drawings.

### BRIEF DESCRIPTION OF THE DRAWINGS

FIG. 1 is a schematic configurational section view of an image forming system according to an embodiment.

FIG. 2 is a schematic configurational section view of a sheet processing apparatus according to the embodiment.

FIG. 3 is a control block diagram of the image forming system according to the embodiment.

FIG. 4 is an enlarged section view of a saddle portion according to the embodiment.

FIG. 5 is a front view of a folding processing portion according to the embodiment.

FIG. 6A is a perspective view of a square back processing unit according to the embodiment.

FIG. 6B is a section view of the square back processing unit according to the embodiment.

FIG. 7A is a perspective view of an additional folding processing portion according to the embodiment as viewed from the front side.

FIG. 7B is a perspective view of the additional folding processing portion according to the embodiment as viewed from the rear side.

FIG. 8 is a perspective view of part of the square back processing unit and a driving portion according to the embodiment.

FIG. 9 is a perspective view of the vicinity of the square back processing unit and a clamp portion according to the embodiment.

FIG. 10 is a section view of the square back processing unit and the clamp portion according to the embodiment.

FIG. 11A is a schematic diagram illustrating a state in which conveyance of a sheet bundle is stopped by a clamp unit in an operation of a square back process in the embodiment.

FIG. 11B is a schematic diagram illustrating a state in which the sheet bundle is clamped in the operation of the square back process in the embodiment.

FIG. 11C is a schematic diagram illustrating a state in which the square back process is performed on the sheet bundle in the operation of the square back process in the embodiment.

FIG. 11D is a schematic diagram illustrating a state in which the clamping of the sheet bundle is released in the operation of the square back process in the embodiment.

FIG. 12A is a perspective view of the sheet processing apparatus according to the embodiment in a state in which a front cover is closed.

FIG. 12B is a perspective view of the sheet processing apparatus according to the embodiment in a state in which the front cover is open.

FIG. 13 is a perspective view of the sheet processing apparatus according to the embodiment in a state in which a saddle portion has been drawn out.

FIG. 14A is a partially-omitted perspective view of elements around a support leg portion according to the embodiment and illustrates an accommodated state of the saddle portion.

FIG. 14B is a partially-omitted perspective view of elements around the support leg portion according to the embodiment and illustrates a state immediately after the saddle portion has been drawn out.

FIG. 15A is a diagram illustrating the accommodated state of the saddle portion according to the embodiment and illustrates part of the elements around the support leg portion in section view.

FIG. 15B is a section view of the elements around the support leg portion illustrating the accommodated state of the saddle portion according to the embodiment.

FIG. 16A is a diagram illustrating the state immediately after the saddle portion according to the embodiment has been drawn out and illustrates part of the elements around the support leg portion in section view.

FIG. 16B is a section view of the support leg portion and a rail stay illustrating the state immediately after the saddle portion according to the embodiment has been drawn out.

FIG. 17A is a perspective view of the support leg portion and the rail stay according to the embodiment.

FIG. 17B is a perspective view of the support leg portion and the rail stay as viewed from the opposite side to FIG. 17A.

FIG. 18 is a section view of the support leg portion and the rail stay according to the embodiment illustrating a state in which pivoting of the support leg portion is restricted.

FIG. 19 is a perspective view of an abutting member according to the embodiment.

FIG. 20A is a diagram illustrating the accommodated state of the saddle portion in which part of the elements around the support leg portion according to the embodiment are illustrated in section view.

FIG. 20B is a diagram illustrating a state at the start of the draw-out of the saddle portion in which part of the elements around the support leg portion according to the embodiment are illustrated in section view.

FIG. 20C is a diagram illustrating a state in which the support leg portion is starting to pivot in which part of the elements around the support leg portion according to the embodiment are illustrated in section view.

FIG. 20D is a diagram illustrating a state in which the support leg portion has pivoted more in which part of the elements around the support leg portion according to the embodiment are illustrated in section view.

FIG. 20E is a diagram illustrating a state in which the pivoting of the support leg portion has been finished in which part of the elements around the support leg portion according to the embodiment are illustrated in section view.

FIG. 20F is a diagram illustrating a state in which a stopper of the support leg portion is functioning in which part of the elements around the support leg portion according to the embodiment are illustrated in section view.

FIG. 21 is a front view of a sheet accommodating apparatus according to another example of the embodiment.

### DESCRIPTION OF THE EMBODIMENTS

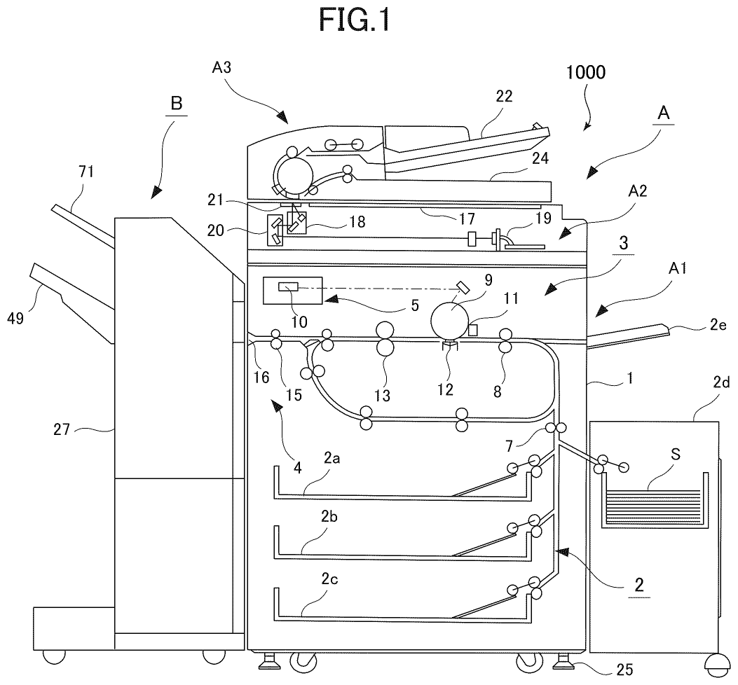

An embodiment will be described with reference to FIGS. 1 to 20F. First, a schematic configuration of an image forming system of the present embodiment will be described with reference to FIG. 1.

### Image Forming System

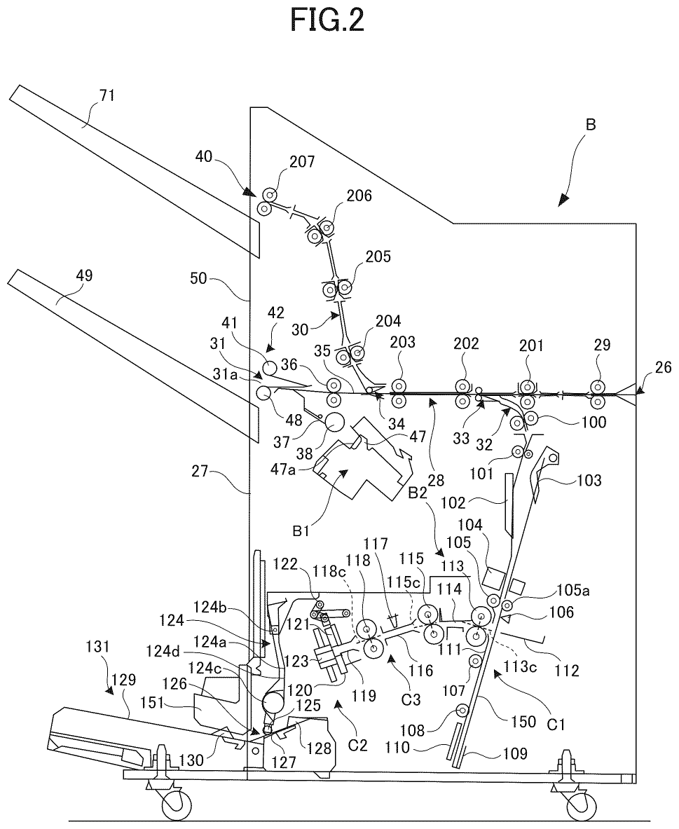

In the present embodiment, a copier is used as the image forming apparatus. A sheet processing apparatus is connected to a sheet discharge port of this copier, and the sheet processing apparatus includes a saddle portion that performs a saddle binding process and a half-folding process. The image forming system 1000 includes an image forming apparatus A and a sheet processing apparatus B. A sheet S on which an image has been formed by the image forming apparatus A is received by the sheet processing apparatus B provided on the downstream side, is subjected to the saddle binding process, the half-folding process, the square back process, and the like if necessary, and is discharged to a discharge portion provided on the downstream side. Examples of the image forming apparatus A include apparatuses of various structures such as copiers, printer, printing machines, facsimile machines, and multifunctional apparatuses having a plurality of functions of these. The image forming apparatus A and the sheet processing apparatus B will be described in detail below. To be noted, in the description below, regarding the image forming apparatus A and the sheet processing apparatus B, the side on which an operator such as a user operates the apparatus (for example, the side on which an operation panel, an operation button, and the like are provided) will be referred to as the front side (F side, front side of the paper surface in FIGS. 1, 2, and the like), and the side opposite to the front side will be referred to as the back side (B side, rear side of the paper surface in FIGS. 1, 2, and the like).

### Image Forming Apparatus

As illustrated in FIG. 1, the image forming apparatus A includes an image forming unit A1, an image reading unit A2, and a document feeding unit A3. The image forming unit A1 includes, in a housing 1, a feeding portion 2, an image forming portion 3, a discharge portion 4, and a data processing portion 5.

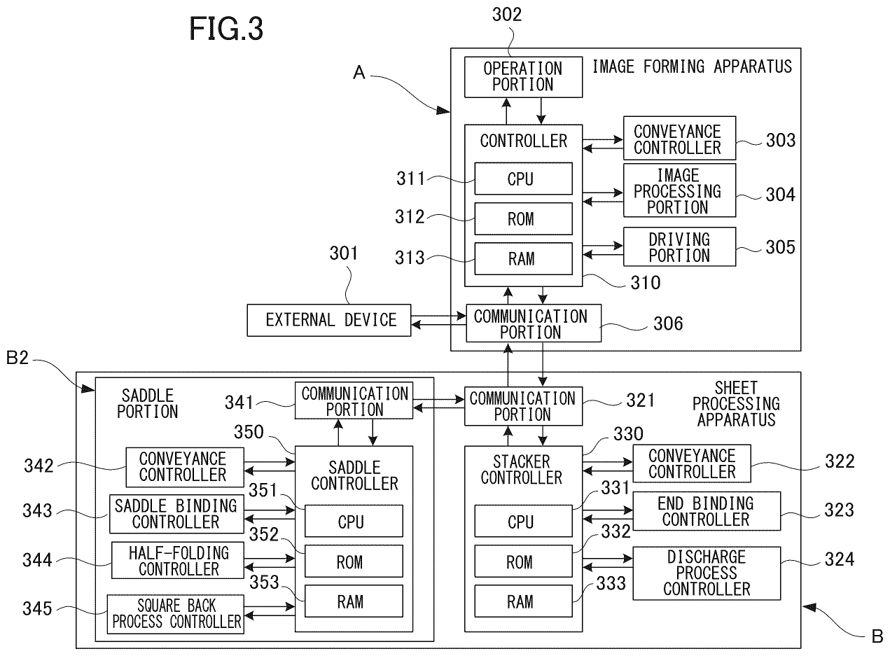

The feeding portion 2 includes a plurality of cassettes 2a, 2b, and 2c, and in the cassettes 2a, 2b, and 2c are capable of accommodating, in a plurality of tiers, sheets S of different regular sizes that are selected in advance. The sheet S is, for example, a paper sheet, a plastic sheet, or the like. The cassettes 2a, 2b, and 2c each include a separation mechanism that separates the sheets S stored therein from each other, and a feeding mechanism that delivers out the sheet S. Regarding the sheet S accommodated in the feeding portion 2 configured in this manner, the sheet S of a size designated by a controller 310 (FIG. 3) of the image forming apparatus A is delivered out. The sheet S fed from one of the plurality of cassettes 2a, 2b, and 2c is conveyed further downstream by a conveyance roller 7. The leading end of the sheet S conveyed by the conveyance roller 7 is aligned by a registration roller pair 8, and thus the skew thereof is corrected. Then, the sheet S whose leading end is aligned by the registration roller pair 8 is fed to the image forming portion 3 provided on the downstream side at a predetermined timing.

A sheet accommodating apparatus 2d and a manual feed tray 2e are coupled to the image forming apparatus A. The sheet accommodating apparatus 2d is constituted by an optional unit that accommodates sheets of a size that is to be consumed by a large amount. The manual feed tray 2e is configured to be capable of supplying special sheets such as cardboard sheets, coated sheets, and film sheets that are difficult to convey while separating the sheets from each other.

It suffices as long as the image forming portion 3 is configured to form an image on the sheet S fed from the feeding portion 2, and various image forming mechanisms can be employed. In the illustrated embodiment, an electrostatic image forming mechanism is illustrated as the image forming portion 3. However, the image forming portion 3 is not limited to the electrostatic image forming mechanism that is illustrated, and an ink jet image forming mechanism, an offset image forming mechanism, and the like can be also employed.

The image forming portion 3 illustrated in FIG. 1 is provided with a photosensitive member 9 formed in a drum shape or a belt shape, an exposing unit 10 that exposes the photosensitive member 9, a developing unit 11 that develops an electrostatic latent image on the photosensitive member 9 by using toner, and a cleaner (not illustrated) that cleans an unillustrated charging unit that charges the photosensitive member 9, the photosensitive member 9, and the like. In FIG. 1, a monochromatic printing mechanism is illustrated as an example. An electrostatic latent image is formed on the photosensitive member 9 by exposure by the exposing unit 10 and is developed by the developing unit 11, and thus a toner image is formed on the photosensitive member 9. The toner image formed on the photosensitive member 9 is, by a transfer unit 12, transferred onto the sheet S conveyed from the registration roller pair 8. The sheet S onto which a toner image has been transferred is fixed by the fixing unit 13. In addition, the image forming apparatus A is provided with a reverse conveyance path, the sheet S to which the toner image has been fixed by a fixing unit 13 is inverted such that the front surface and the back surface thereof are switched and is then conveyed to the registration roller pair 8 again, and image formation is performed on the back surface of the sheet S. A discharge roller 15 is provided downstream of the fixing unit 13 and downstream of a branching point to the reverse conveyance path, and conveys the sheet S from a discharge port 16 of the image forming apparatus A to the sheet processing apparatus B that will be described later.

An image reading unit A2 that optically reads a document image is provided above the image forming unit A1 configured in this manner, and a document feeding unit A3 is further provided above the image reading unit A2.

The image reading unit A2 includes a first platen glass 17, a second platen glass 21, a reading carriage 18 including a light source, a photoelectric conversion element 19, and a reduction optical system 20 constituted by combining mirrors and lenses. Further, the reading carriage 18 is moved in a scanning manner along the first platen glass 17 to irradiate an image of a document placed on the first platen glass 17 with light from the light source, and reflection light from the image of the document is guided to the photoelectric conversion element 19 through the reduction optical system 20 to read the image. The photoelectric conversion element 19 converts image data into an electric signal and transfers the electric signal to the image forming portion 3, and thus the image read by the image reading unit A2 can be formed on a sheet by the image forming unit A1.

The document feeding unit A3 includes a feeding tray 22 and a discharge tray 24, conveys documents placed on the feeding tray 22 one by one through a space on the second platen glass 21, and discharges the document onto the discharge tray 24. To be noted, when reading the document fed by the document feeding unit A3 and passing through the space on the second platen glass 21, the reading carriage 18 is stopped at a position below the second platen glass 21 in advance, and image data is read from an image passing through the space on the second platen glass 21.

### Overall Configuration of Sheet Processing Apparatus

Next, an overall configuration of the sheet processing apparatus B that performs a process such as a stapling process, a folding process, and the like on sheets conveyed from the image forming apparatus A will be described next with reference to FIG. 2. FIG. 2 illustrates a detailed configuration of the sheet processing apparatus B. The sheet processing apparatus B is capable of stacking sheets on a first tray (first stacking tray) 49, a saddle discharge unit 131, and a second tray (second stacking tray) 71 that will be described later after processing the sheets received through an inlet portion 26 serving as an inlet of a conveyance path 28 continuous from the discharge port 16. In the present embodiment, a path refers to the entirety of a path in which a sheet is conveyed by a conveyance guide, a conveyance roller, and the like.

In the illustrated apparatus, the sheet conveyed to the conveyance path 28 serving as a first conveyance path is discharged onto a first tray 49 after being processed by a processing portion B1 that will be described later, or the sheet conveyed in the conveyance path 28 is discharged onto the second tray 71, or is discharged to a saddle discharge unit 131 after being processed by a saddle portion B2 that will be described later. Each apparatus includes a controller, a communication portion, and the like as indicated by blocks representing the overall control configuration of the apparatus illustrated in FIG. 3, and thus the apparatus is controlled.

The processing portion B1 serving as an end binding processing portion is disposed below a path outlet (passing portion 35) of the conveyance path 28, and is capable of accumulating a plurality of sheets sequentially passed on thereto from the conveyance path 28 through the passing portion 35 for each copy to form a sheet bundle, and executing a binding process on an end portion of the sheet bundle. The sheet bundle subjected to the binding process is stacked on the first tray 49 serving as a stacking portion. The trailing end (upstream end) of the sheet or sheet bundle stacked on the first tray 49 abuts a stacking wall 50 provided on the upstream side in the sheet discharge direction of the first tray 49, and is thus stacked along the stacking wall 50.

The first tray 49 is capable of moving up and down with respect to a processing tray 37 that will be described later, and supports thereon a sheet bundle subjected to the binding process by a binding processing mechanism 47 that will be described later. In the present embodiment, the first tray 49 and the second tray 71 are capable of moving up and down by an unillustrated lifting/lowering mechanism. That is, in the present embodiment, when delivering out the sheet onto the first tray 49 or the second tray 71 serving as a stacking tray, the first tray 49 or the second tray 71 is moved up or down to maintain the position of the uppermost sheet on the stacking surface of the tray constant with respect to the discharge roller pair 42 and a second discharge roller 207 such that the alignment of the stacked sheets is not degraded.

The saddle portion B2 is disposed below the passing portion of the saddle path 32 serving as a second conveyance path branching downward in the vertical direction from the conveyance path 28, accumulates a plurality of sheets sequentially passed on thereto from the conveyance path 28 through the saddle path 32 and the passing portion for each copy to form a sheet bundle, performs a folding process after executing a saddle binding process or without performing the saddle binding process, and discharges the sheet bundle to the saddle discharge unit 131. Detailed description of each configuration will be given below.

### Housing

As illustrated in FIG. 2, the sheet processing apparatus B includes a housing 27, the conveyance path 28, the processing portion B1, the saddle portion B2, the first tray 49, the saddle discharge unit 131, the second tray 71, and the like. The conveyance path 28, the processing portion B1, and the saddle portion B2 are disposed inside the housing 27. In addition, the conveyance path 28 includes the inlet portion 26 and the passing portion 35 for the sheet. The processing portion B1 and the saddle portion B2 process the sheet passed on thereto from the passing portion 35 of the conveyance path 28. The first tray 49, the saddle discharge unit 131, and the second tray 71 support thereon a sheet conveyed from each processing portion. The illustrated housing 27 is connected to a housing 1 of the image forming apparatus A positioned upstream thereof in the sheet conveyance direction in the conveyance path 28. Further, the housing 27 and the housing 1 are disposed such that the height of the discharge port 16 of the image forming apparatus A from the installation surface and the height of the inlet portion 26 of the sheet processing apparatus B from the installation surface are approximately equal, and the discharge port 16 and the inlet portion 26 are connected.

### Sheet Introduction Path

The conveyance path 28 serving as a sheet introduction path is configured as an approximately linear path traversing the housing 27 in an approximately horizontal direction, and includes the inlet portion 26 continuous with the discharge port (body discharge port) 16 of the image forming apparatus A and the passing portion 35 positioned on the opposite side across the apparatus with respect to the inlet portion 26. In the conveyance path 28, an inlet roller 29, a first conveyance roller 201, a second conveyance roller 202, and a third conveyance roller 203 serving as conveyance rollers capable of conveying the sheet in a first straight conveyance direction from the inlet portion 26 toward a first discharge path 31 and capable of conveying the sheet in a second straight conveyance direction from the first discharge path 31 toward the inlet portion 26. That is, the inlet roller 29, the first conveyance roller 201, the second conveyance roller 202, and the third conveyance roller 203 are capable of conveying the sheet in the first straight conveyance direction and the second straight conveyance direction opposite to the first straight conveyance direction in the conveyance path, and are arranged in this order from the inlet portion 26 side in the first straight conveyance direction.

The first discharge path 31 is connected to the passing portion 35 of the conveyance path 28, and the first conveyance roller 36 is disposed at a connecting portion of these. The sheet passed on from the conveyance path 28 to the first discharge path 31 and discharged from the first discharge path 31 is stacked on the first tray 49 or guided to the processing portion B1. To be noted, each conveyance roller described above may be a different member capable of conveying a sheet such as a conveyance belt.

### Layout of Sheet Introduction Path

The saddle path 32 and the upper conveyance path 30 that are branch paths are connected to the conveyance path 28 as illustrated in FIG. 2. The saddle path 32 and the upper conveyance path 30 are arranged in this order from the inlet portion 26 toward the first discharge path 31 in the first straight conveyance direction. In addition, the saddle path 32 branches downward from the conveyance path 28 in the vertical direction, and the upper conveyance path 30 branches upward from the conveyance path 28 in the vertical direction. A saddle path switching member 33 and an upper conveyance path switching member 34 serving as switching members that switch the conveyance direction of the conveyed sheet are respectively disposed at the respective branching portions between the conveyance path 28 and the saddle path 32 and between the conveyance path 28 and the upper conveyance path 30.

### Branching Portion of Path

The upper conveyance path switching member 34 is constituted by a switching guide capable of moving to change the conveyance path of the sheet introduced from the inlet portion 26 to convey the sheet to the first discharge path 31 or the upper conveyance path 30, and is moved by a driving portion (not illustrated) such as an electromagnetic solenoid or a mini motor.

### Upper Conveyance Path

The upper conveyance path 30 (print-out discharge path) in which a sheet other than a sheet to be discharged to the first discharge path 31 is conveyed branches from the conveyance path 28, and the upper conveyance path switching member 34 for guiding the sheet to the upper conveyance path 30 is provided at the path branching portion thereof. In addition, in the upper conveyance path 30, a fourth conveyance roller 204, a fifth conveyance roller 205, a sixth conveyance roller 206, and a second discharge roller 207 are provided in the upper conveyance path 30 as conveyance rollers that guide the sheet to the second tray 71. As a result of this, the sheet guided to the upper conveyance path 30 is discharged onto the second tray 71 (overflow tray) from an upper conveyance path discharge port 40.

The processing portion B1 is constituted by a processing tray 37 serving as a placement portion that places thereon a sheet conveyed through the first discharge path 31 provided downstream of the conveyance path 28 and accumulates a plurality of placed sheets for each copy, and a binding processing mechanism 47 that performs a binding process on the accumulated sheet bundle. Further, the processing portion B1 performs a binding process on the sheet bundle placed on the processing tray 37. The binding processing mechanism 47 is disposed below the conveyance path 28 in the vertical direction. As illustrated in FIG. 2, a step is formed in the first discharge path 31, and the processing tray 37 is disposed below the step. A first switchback path in which the sheet is guided onto the processing tray 37 after reversing the conveyance direction in a state in which part of the sheet has been discharged onto the first tray 49 through the discharge port 31a of the first discharge path 31 is provided between the first discharge path 31 and the processing tray 37.

Specifically, in the first discharge path 31, an upper conveyance roller 41 and a lower conveyance roller 48 that nip and convey the sheet are provided. The upper conveyance roller 41 and the lower conveyance roller 48 constitute a discharge roller pair 42 serving as a discharge portion. The upper conveyance roller 41 is capable of coming into and out of contact with and from the lower conveyance roller 48, and the sheet can be conveyed in a direction toward the first tray 49 and a direction opposite to this direction in a state in which the sheet is nipped between the upper conveyance roller 41 and the lower conveyance roller 48. Further, the sheet can be conveyed toward the processing tray 37 through the first switchback path by the upper conveyance roller 41 and the lower conveyance roller 48.

In addition, the upper conveyance roller 41 and the lower conveyance roller 48 (that is, the discharge roller pair 42) discharge the sheet or sheet bundle on the processing tray 37 onto the first tray 49 serving as a stacking tray (stacking portion) through the discharge port 31a. The discharge port 31a is a portion opening at a position above the lower conveyance roller 48 in the housing 27. Further, the discharge roller pair 42 discharges the sheet conveyed to the first discharge path 31 without passing the processing tray 37 onto the first tray 49 through the discharge port 31a.

The binding processing mechanism 47 includes a trailing end regulating portion 47a that abuts an end portion (trailing end) of the sheet and positions the sheet. A reversing portion 38 that conveys the sheet conveyed to the processing tray 37 by the upper conveyance roller 41 and the lower conveyance roller 48 toward the trailing end regulating portion 47a is disposed on the processing tray 37. Further, the binding processing mechanism 47 performs a binding process on an end portion of a sheet bundle constituted by a plurality of sheets which are placed on the processing tray 37 and a position of an end portion of which is regulated by the trailing end regulating portion 47a. In addition, the binding processing mechanism 47 includes a sheet bundle discharge mechanism that discharges the sheet bundle onto the first tray 49 after performing the binding process on the end portion of the sheet bundle.

To be noted, the binding processing mechanism 47 illustrated in FIG. 2 supports the sheet conveyed from the first discharge path 31 such that the sheet bridges the processing tray 37 and the first tray 49 provided downstream thereof. That is, the sheet conveyed from the first discharge path 31 is supported such that the leading end portion of the sheet is supported on the uppermost sheet on the first tray 49 provided on the downstream side, and the trailing end portion of the sheet is supported on the processing tray 37.

### Saddle Path

The saddle path 32 for conveying the sheet to the saddle portion B2 described above is coupled to the conveyance path 28, and the saddle path switching member 33 for guiding the sheet to the saddle path 32 is provided at the path branching portion thereof. The sheet guided to the saddle portion B2 through the saddle path 32 is subjected to the half-folding process, and after being subjected to the folding process, is discharged to the saddle discharge unit 131 via a post-folding path guide 114, a post-second roller path guide 116, a pre-clamp guide 119, and a saddle discharge guide 124. In the present embodiment, the saddle discharge guide 124 serving as a discharge guide portion is used as an auxiliary guide for appropriately stacking the sheet on the saddle discharge unit 131.

### Control Configuration

The outline of a control configuration of the image forming system 1000 will be described with reference to FIG. 3. First, the image forming apparatus A includes a controller 310, an operation portion 302, a conveyance controller 303, an image processing portion 304, a driving portion 305, and a communication portion 306. The controller 310 includes a central processing unit: CPU 311, a read-only memory: ROM 312, and a random access memory: RAM 313. The CPU 311 controls each component while reading out a program corresponding to a control procedure stored in the ROM 312. In addition, the RAM 313 stores work data and input data, and the CPU 311 performs control with reference to data stored in the RAM 313 on the basis of the program described above and the like.

The operation portion 302 is, for example, an operation panel provided in the image forming apparatus A and connected to the controller 310, and an operator operates the apparatus and performs various settings thereby. The conveyance controller 303 controls the various conveyance rollers that convey the sheet and the switching members that switch the conveyance path in the image forming apparatus A. The image processing portion 304 controls the image forming portion 3. The driving portion 305 controls various motors and the power source. The communication portion 306 communicably connects an external device 301 such as a personal computer and a communication portion 321 of the sheet processing apparatus B with the controller 310.

The sheet processing apparatus B includes a stacker controller 330, a conveyance controller 322, an end binding controller 323, a discharge process controller 324, and the communication portion 321. The stacker controller 330 includes a CPU 331, a ROM 332, and a RAM 333 similarly to the controller 310. The conveyance controller 322 controls the various conveyance rollers that convey the sheet and the switching members that switch the conveyance path in part of the sheet processing apparatus B other than the saddle portion B2. The end binding controller 323 controls the processing portion B1. The discharge process controller 324 controls various stacking trays onto which sheets are discharged and on which the discharged sheets are stacked. The communication portion 321 communicably connects the communication portion 306 of the image forming apparatus A and a communication portion 341 of the saddle portion B2 with the stacker controller 330. To be noted, the communication between the communication portion 306 and the communication portion 321 may be performed by wired communication or wireless communication.

The saddle portion B2 includes a saddle controller 350, a conveyance controller 342, a saddle binding controller 343, a half-folding controller 344, a square back process controller 345, and a communication portion 341. The saddle controller 350 includes a CPU 351, a ROM 352, and a RAM 353 similarly to the controller 310. The conveyance controller 342 controls the various conveyance rollers that convey the sheet and the switching members that switch the conveyance path in the saddle portion B2. The saddle binding controller 343 controls the saddle binding processing portion 104. The half-folding controller 344 controls a half-folding processing mechanism C1. The square back process controller 345 controls a square back processing portion C2. The communication portion 341 communicably connects the communication portion 321 of the sheet processing apparatus B with the saddle controller 350. To be noted, although a configuration in which the saddle controller 350 communicates with the stacker controller 330 via the communication portions 341 and 321 is employed in the present embodiment, a configuration in which each unit is controlled by the same controller may be employed. In addition, although the conveyance controller 322, the end binding controller 323, the discharge process controller 324, the stacker controller 330, and the saddle controller 350 are provided as elements that control the sheet processing apparatus B in the present embodiment, a configuration in which each unit is controlled by the same controller may be employed.

### Saddle Portion

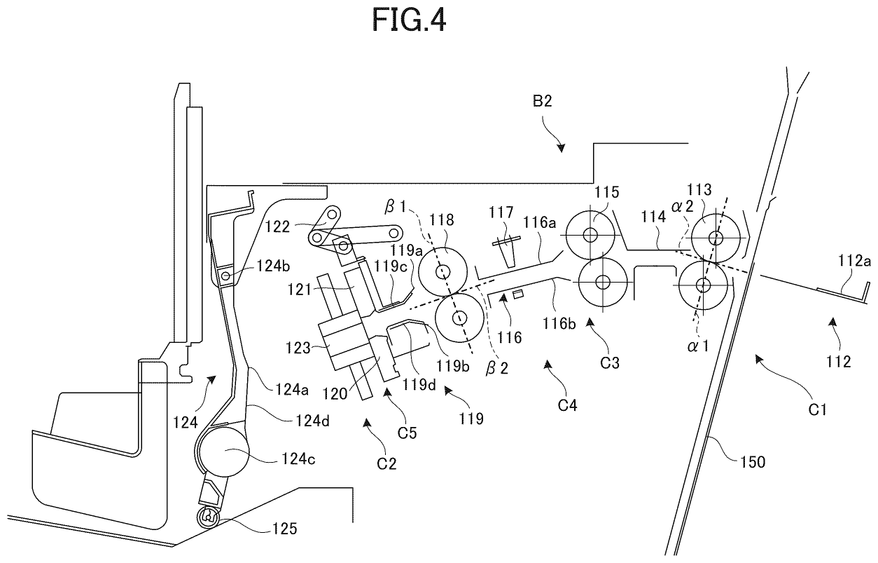

The saddle portion B2 will be described with reference to FIGS. 2 and 4. The saddle portion B2 includes the half-folding processing mechanism C1 and the square back processing portion C2, and performs a half-folding process, a saddle binding process, and a square back process as a predetermined process. The predetermined process may be any one of these processes, or a plurality of processes among these. The half-folding processing mechanism C1 accumulates sheets conveyed from the conveyance path 28 for each copy to form a sheet bundle, performs a binding process on a center portion in the conveyance direction (center portion in a second conveyance direction that is a conveyance direction of the saddle path roller 100 serving as a second conveyance portion that will be described later) of the sheet bundle, and performs a half-folding process (hereinafter also referred to as a “magazine finish”) in which the sheet bundle is folded at a position subjected to the binding process. The square back processing portion C2 is disposed downstream of the half-folding processing mechanism C1 in the conveyance direction of the sheet bundle (downstream in the first conveyance direction that is the conveyance direction of a saddle third roller pair 118 serving as a first conveyance portion that will be described later), and performs a square back process of forming a folding line on the spine of the sheet bundle subjected to the half-folding process. Further, the saddle discharge unit 131 is disposed downstream of the square back processing portion C2 in the first conveyance direction, and the sheet bundle subjected to a bookbinding process is stacked on the saddle discharge unit 131. To be noted, only the half-folding process of folding the center portion of the sheet in the conveyance direction may be performed without performing the saddle binding process and the square back process after accumulating one sheet or a plurality of sheets for each copy.

### Half-Folding Mechanism

The half-folding processing mechanism C1 includes a leading end regulating stopper 109, a saddle binding processing portion (saddle binding stapling unit) 104, and a half-folding processing portion 112, accumulates sheets into a bundle shape, and performs the half-folding process and the saddle binding process. That is, the sheet conveyed from the conveyance path 28 to the saddle path 32 is conveyed to the saddle stacking tray 150 serving as an accumulation portion and a second accumulation portion by the saddle path roller 100 serving as a second conveyance portion. The saddle stacking tray 150 forms a sheet bundle by accumulating a plurality of sheets conveyed in the second conveyance direction by the saddle path roller 100 through the saddle path 32. The sheet bundle accumulated on the saddle stacking tray 150 is positioned at a predetermined position on the saddle stacking tray 150 by the leading end regulating stopper 109. The saddle binding processing portion 104 performs the binding process on a center portion in the conveyance direction (middle portion in the second conveyance direction) of the sheet bundle positioned by the leading end regulating stopper 109. The half-folding processing portion 112 includes the folding plate 112a and the folding roller pair 113, and by conveying the sheet bundle by the folding roller pair 113 while poking the vicinity of the position subjected to the binding process by the saddle binding processing portion 104 (center portion in the conveyance direction of the sheet bundle in the binding process) by the folding plate 112a, the sheet bundle is folded and conveyed such that the spine of the sheet bundle is on the downstream side in the conveyance direction. To be noted, the half-folding processing portion 112 is also capable of performing the half-folding process on a sheet bundle (or a single sheet) not subjected to the binding process. Here, the half-folding process is a process of folding the sheet bundle in half by forming a folding line near the center of the sheet bundle. The folding line formed by the half-folding processing portion 112 does not need to be positioned at the center of the sheet bundle, and may be displaced from the center within the range of the tolerance of parts. In addition, the folding position may be changed by user settings.

The saddle binding processing portion 104 is a mechanism that performs the binding process of moving a head unit and an anvil unit along the sheet center portion (line) while nipping the sheet bundle between the head unit and the anvil unit. In addition, for the half-folding processing portion 112, as illustrated in FIGS. 2 and 4, a configuration in which the sheet bundle is inserted in the nip of the folding roller pair 113 in pressure contact with each other by the folding plate 112a, and the sheet bundle is conveyed while being folded by the rotation of the folding roller pair 113 is employed.

### Square Back Processing Portion

The square back processing portion C2 performs, on the sheet bundle, the square back process to form a square back shape along the folding line of the sheet bundle subjected to the half-folding process. The square back processing portion C2 includes a lower clamp unit 120 and an upper clamp unit 121 serving as a pair of clamp portions (nipping unit), and a square back processing unit 134 including a pressing roller 123.

The lower clamp unit 120 and the upper clamp unit 121 relatively move along the thickness direction (direction in which a virtual line connecting rotational axes of the saddle third roller pair 118 extends, or direction orthogonal to the conveyance direction 118c of the saddle third roller pair 118) of the sheet bundle conveyed by a saddle third roller pair 118 that will be described later, and thus nip the sheet bundle and release the nipping of the sheet bundle. The pressing roller 123 moves along the width direction of the sheet bundle (direction orthogonal to the conveyance direction of the sheet bundle, front-rear direction of FIGS. 2 and 4), and thus presses the spine of the sheet bundle. Further, the square back processing portion C2 performs a square back process of forming a corner on the spine of the sheet bundle by pressing, by the pressing roller 123, the spine of the sheet bundle nipped between the lower clamp unit 120 and the upper clamp unit 121 in a state in which the spine of the sheet bundle protrudes downstream with respect to the lower clamp unit 120 and the upper clamp unit 121 in the first conveyance direction. To be noted, examples of the “corner” described above include a curved surface, and refers to a boundary between the front cover and the spine of the sheet bundle and a boundary between the spine and the back cover of the sheet bundle. In addition, the “width direction of the sheet bundle” is a direction along the front-rear direction (F-B direction) of the image forming apparatus A and the sheet processing apparatus B, and may be simply referred to as a “width direction” in the description below.

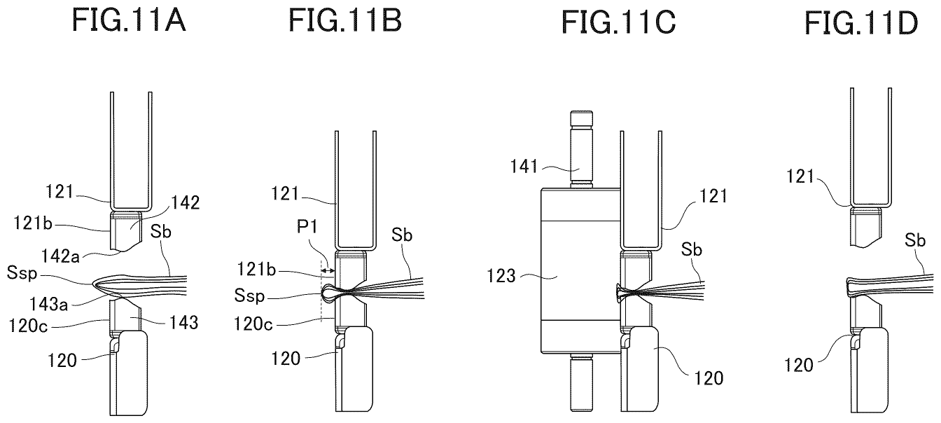

Specifically, the square back processing portion C2 nips part of the sheet bundle from both sides in the vertical direction (thickness direction of the sheet bundle) by the lower clamp unit 120 and the upper clamp unit 121 in a state in which the spine of the sheet bundle subjected to the half-folding by the half-folding processing mechanism C1 protrudes downstream in the first conveyance direction. The pressing roller 123 presses the spine of the sheet bundle nipped between the lower clamp unit 120 and the upper clamp unit 121, while moving in the width direction of the sheet bundle orthogonal to the conveyance direction of the sheet bundle and to the thickness direction of the sheet bundle. In this manner, the square back processing portion C2 performs the square back process of forming a corner on the spine of the sheet bundle. The square back process is a process of forming two corners on the spine of the sheet bundle by forming two streaks on the spine of the sheet bundle as illustrated in FIGS. 11C and 11D by crushing the spine of the sheet bundle illustrated in FIGS. 11A and 11B that will be described later by the pressing roller 123. The two corners on the spine of the sheet bundle are formed at positions between which the staples embedded in the sheet bundle in the binding process by the saddle binding processing portion 104 are positioned in the thickness direction of the sheet bundle. In addition, the two corners formed on the spine of the sheet bundle are formed at positions between which a folding line formed in the half-folding process by the half-folding processing portion 112 is positioned.

To be noted, a half-folding conveyance mechanism that conveys the sheet bundle subjected to the half-folding process by the half-folding processing mechanism C1 to the square back processing portion C2 positioned downstream and stops the conveyance is disposed between the half-folding processing mechanism C1 and the square back processing portion C2.

As described above, the processing portion B1 and the conveyance path 28 are arranged in approximately the horizontal direction, the saddle path 32 that guides the sheet to the saddle portion B2 is disposed in approximately the vertical direction, and the saddle stacking tray 150 that accumulates the sheets for each copy is disposed to approximately follow the vertical direction. As described above, by disposing the conveyance path 28 along a direction traversing the housing 27 and disposing the saddle path 32 and the saddle portion B2 along approximately the vertical direction, the apparatus can be made slimer, that is, the width of the apparatus in the horizontal direction can be reduced.

The saddle discharge unit 131 is disposed downstream of the saddle portion B2 in the conveyance direction of the sheet bundle, and accommodates a sheet bundle folded into a magazine shape. The saddle discharge unit 131 that is illustrated is disposed below the first tray 49 in the vertical direction. This is because the apparatus has specifications set in consideration of the fact that the frequency of use of the first tray 49 is higher than the frequency of use of the saddle discharge unit 131 and the first tray 49 is set to a height where the sheet on the tray is easy to pick up.

### Configuration of Saddle Portion

Next, the configuration of each of the half-folding processing mechanism C1, the half-folding conveyance mechanism C3, and the square back processing portion C2 constituting the saddle portion B2 will be described in more detail.

### Details of Half-Folding Processing Mechanism

As illustrated in FIG. 2, the saddle path switching member 33 is switched so as to convey the sheet to the saddle path 32, and thus guides the sheet to the half-folding processing mechanism C1. A saddle inlet roller 101, a sorting portion 102, a trailing end pressing guide 103, a saddle binding processing portion 104, a pull-in separation roller 105, a half-folding processing portion 112, a first alignment roller 107, a second alignment roller 108, a leading end regulating stopper 109, and a leading end gripper 110 are disposed in this order from the upper side (upstream side) in the vertical direction that is the inlet side in the height direction of the half-folding processing mechanism C1.

The saddle inlet roller 101 conveys the sheet passed on thereto from the saddle path 32 by the saddle path roller 100 further downward. The sorting portion 102 moves the sheet conveyed downward from the saddle inlet roller 101 to the right side in FIG. 2, and accumulates the sheet on the saddle stacking tray 150. The trailing end pressing guide 103 presses the trailing end of the sheet stacked on the saddle stacking tray 150. The saddle binding processing portion 104 performs the binding process on the center portion in the conveyance direction of the sheet bundle accumulated on the saddle stacking tray 150. The pull-in separation roller 105 supports the conveyance of the sheet conveyed to the saddle stacking tray 150, and is a roller that pulls in this sheet toward the leading end regulating stopper 109. The pull-in separation roller 105 is disposed so as to be capable of coming into contact and out of contact with and from an opposing roller 105a.

The half-folding processing portion 112 includes a folding roller pair 113, the folding plate 112a serving as a pressing portion, and a roller guide 111. The folding roller pair 113 forms a folding line in the half-folding process. The folding plate 112a pushes the sheet into the nip portion of the folding roller pair 113. The roller guide 111 covers the folding roller pair 113. The first alignment roller 107 and the second alignment roller 108 convey the sheet conveyed to the saddle stacking tray 150, and aligns the sheet in the height direction of the sheet. The leading end regulating stopper 109 abuts the leading end (lower end) of the sheet conveyed thereto, and determines the position of the leading end of the sheet in the height direction. The leading end gripper 110 presses the leading end (lower end) of the sheet stacked on the leading end regulating stopper 109.

The saddle inlet roller 101 and the pull-in separation roller 105 are driven by the same motor. The trailing end pressing guide 103 is provided at a position opposing the sorting portion 102 with respect to the saddle stacking tray 150. The saddle binding processing portion 104 is disposed downstream of the sorting portion 102 and the trailing end pressing guide 103 and upstream of the pull-in separation roller 105.

The sheet conveyed from the saddle path 32 to the saddle portion B2 is conveyed to the leading end regulating stopper 109 moved to a position corresponding to the size by the saddle inlet roller 101. The pull-in separation roller 105 has an auxiliary conveyance function for precisely conveying the conveyed sheet to the leading end regulating stopper 109 in the saddle stacking tray 150. The roller guide 111 partially covers the folding roller pair 113 so as to suppress the leading end of the sheet getting caught at the folding roller pair 113 at this time and efficiently convey the sheet.

The first alignment roller 107 and the second alignment roller 108 cause the conveyed sheet to precisely abut the leading end regulating stopper 109, and thus performs an alignment process in the sheet height direction.

The sorting portion 102 moves the sheet conveyed to the leading end regulating stopper 109 to the trailing end pressing guide 103, and by pressing the trailing end (upper end) of the moved sheet by the trailing end pressing guide 103, preparation for receiving the next sheet is performed. At this time, the trailing end pressing guide 103 has moved to a position corresponding to the size and is standing by.

The leading end (trailing end) of the sheet bundle formed by stacking a plurality of sheets on the saddle stacking tray 150 is fixed by being gripped by the leading end gripper 110. In this state, the binding process is performed on the center portion in the second conveyance direction of the sheet bundle by the saddle binding processing portion 104. After the binding process, the leading end regulating stopper 109 is moved down while the leading end (lower end) of the sheet bundle is still gripped by the leading end gripper 110. At this time, by moving down the leading end regulating stopper 109 such that the position in the sheet where the sheet is pushed into the folding roller pair 113 by the folding plate 112a is a position of ½ of the sheet size, the sheet bundle is moved down from the binding position.

When performing the half-folding process, the roller guide 111 is retracted, the fixation by the leading end gripper 110 is released, and then the center portion of the sheet bundle is pushed into the nip portion of the folding roller pair 113 by the folding plate 112a. As a result of this, the half-folding process is performed on the sheet bundle.

The saddle inlet roller 101, the pull-in separation roller 105, the sorting portion 102, and the trailing end pressing guide 103 are controlled by the conveyance controller 342 (FIG. 3). In addition, the leading end regulating stopper 109, the leading end gripper 110, the saddle binding processing portion 104, the first alignment roller 107, and the second alignment roller 108 are controlled by the saddle binding controller 343 (FIG. 3). Further, the folding roller pair 113 and the folding plate 112a are controlled by the half-folding controller 344 (FIG. 3).

### Half-Folding Conveyance Mechanism

The configuration of the half-folding conveyance mechanism C3 will be described with reference to FIGS. 2 and 4. The half-folding conveyance mechanism C3 is a mechanism that passes on the sheet bundle subjected to the half-folding process by the half-folding processing mechanism C1 to the square back processing portion C2. Specifically, the half-folding conveyance mechanism C3 first conveys the sheet bundle subjected to the half-folding process as it is by the folding roller pair 113 such that the spine of the sheet bundle is positioned downstream of the fore edge in the conveyance direction, and passes on the sheet bundle to the post-folding path guide 114. The post-folding path guide 114 is disposed at a position downstream of the folding roller pair 113 in the conveyance direction and is disposed along a direction (approximately horizontal direction herein) bending downward in the vertical direction from a folding roller conveyance direction 113c (FIG. 2) following a line (first virtual line α2 that will be described later, FIG. 4) perpendicular to a straight line passing through the rotational center of each roller of the folding roller pair 113 serving as a first conveyance roller pair.

Here, as illustrated in FIG. 4, a straight line orthogonal to a first line α1 passing through the rotational centers of the folding roller pair 113 and to the width direction (direction orthogonal to the conveyance direction of the sheet bundle, front-rear direction of FIGS. 2 and 4) and passing through the nip of the folding roller pair 113 not nipping the sheet bundle is set as the first virtual line α2. In this case, the folding roller pair 113 is disposed such that the first virtual line α2 is parallel to the horizontal direction or is inclined upward in the vertical direction toward the downstream side in the conveyance direction with respect to the horizontal direction. In the present embodiment, the first virtual line α2 is inclined upward in the vertical direction toward the downstream side in the conveyance direction with respect to the horizontal direction. In contrast, the post-folding path guide 114 is provided to extend in a direction inclined with respect to the first virtual line α2, and is provided to extend approximately in the horizontal direction in the present embodiment.

The post-folding path guide 114 guides the conveyance of the sheet bundle, and guides the sheet bundle to a saddle second roller pair 115 positioned on the downstream side in the conveyance direction. A saddle second roller conveyance direction 115c that is a direction following a line perpendicular to a straight line passing through the rotational center of each roller of the saddle second roller pair 115 is provided along a direction inclined downward in the vertical direction toward the downstream side in the conveyance direction. The saddle second roller pair 115 is driven by the half-folding controller 344 and conveys the sheet bundle.

The sheet bundle conveyed by the saddle second roller pair 115 is passed on to the post-second roller path guide 116 disposed on the downstream side in the conveyance direction and disposed parallel to the saddle second roller conveyance direction 115c (FIG. 2), and is guided by the post-second roller path guide 116. In addition, the post-second roller path guide 116 includes a post-second roller path upper guide 116a that guides the upper surface of the sheet bundle and a post-second roller path lower guide 116b that guides the sheet bundle. A saddle conveyance sensor 117 is disposed at a position above the guide surface of the post-second roller path upper guide 116a and between the inlet port for the sheet bundle and the discharge port for the sheet bundle. The saddle conveyance sensor 117 detects the position of the leading end of the sheet bundle.

The post-second roller path guide 116 guides the conveyance of the sheet, and guides the sheet to the saddle third roller pair 118 positioned downstream in the conveyance direction. A saddle third roller conveyance direction 118c (FIG. 2) that is a direction following a line (second virtual line β2 that will be described next, FIG. 4) perpendicular to a straight line passing through the rotational center of each roller of the saddle third roller pair 118 is provided along a direction inclined downward in the vertical direction toward the downstream side in the conveyance direction.

The saddle third roller pair 118 serving as a conveyance portion and a conveyance roller pair is driven by the half-folding controller 344, and nips and conveys the sheet bundle subjected to the saddle binding process and the half-folding process such that the spine of the sheet bundle is positioned downstream of an end portion on the fore edge side in the conveyance direction. That is, the saddle third roller pair 118 conveys the sheet bundle such that the spine of the sheet bundle serves as the leading end. In the case where the direction in which the sheet bundle is conveyed by the saddle third roller pair 118 also serving as a first conveyance portion is set as the first conveyance direction (saddle third roller conveyance direction 118c), the saddle path roller 100 serving as a second conveyance portion that conveys the sheet to the half-folding processing mechanism C1 is positioned upstream of the saddle third roller pair 118 in the first conveyance direction. Further, the saddle path roller 100 conveys the sheet in a second conveyance direction different from the first conveyance direction at a position upstream of the saddle third roller pair 118 in the first conveyance direction. In the description below, the upstream side and the downstream side in the first conveyance direction (saddle third roller conveyance direction 118c) in which the sheet bundle is conveyed by the saddle third roller pair 118 may be sometimes simply referred to as the “upstream side” and the “downstream side”.

To be noted, the folding roller pair 113, the saddle second roller pair 115, and the saddle third roller pair 118 are driven by the same motor, and the half-folding controller 344 controls this motor to control the driving of each roller pair. The saddle third roller pair 118 nips the sheet bundle subjected to half-folding by the half-folding processing portion 112, conveys the sheet bundle toward the square back processing portion C2, and is positioned immediately upstream of the square back processing portion C2.

Here, as illustrated in FIG. 4, a straight line that is orthogonal to a second line β1 passing through the rotational centers of the saddle third roller pair 118 and to the width direction and that passes the nip of the saddle third roller pair 118 not nipping the sheet bundle is set as a second virtual line β2. In this case, the saddle third roller pair 118 is provided such that the second virtual line β2 intersects with the first virtual line α2 and is inclined downward in the vertical direction toward the downstream side of the folding roller pair 113 in the conveyance direction.

In other words, the saddle third roller pair 118 is disposed such that the second virtual line β2 is inclined downward in the vertical direction toward the downstream side in the conveyance direction with respect to the horizontal direction. That is, in the present embodiment, the second virtual line β2 is inclined with respect to the first virtual line α2. Further, the folding roller pair 113 conveys the sheet bundle in the horizontal direction or a direction (folding roller conveyance direction 113c) inclined upward in the vertical direction toward the downstream side in the conveyance direction with respect to the horizontal direction. In contrast, the saddle third roller pair 118 conveys the sheet bundle in a direction (saddle third roller conveyance direction 118c) inclined downward in the vertical direction toward the downstream side in the conveyance direction with respect to the horizontal direction.

Therefore, in the case of the present embodiment, the half-folding conveyance path C4 serving as a third conveyance path in which the sheet bundle is conveyed between the folding roller pair 113 and the saddle third roller pair 118 is bent such that the sheet bundle conveyed by the folding roller pair 113 is passed on to the saddle third roller pair 118. That is, the half-folding conveyance path C4 includes the post-folding path guide 114 and the post-second roller path guide 116, and the conveyance path between the post-folding path guide 114 and the post-second roller path guide 116 is bent. In other words, the direction in which the sheet bundle is guided by the post-second roller path guide 116 is inclined with respect to the direction in which the sheet bundle is guided by the post-folding path guide 114.

As described above, by making the conveyance direction of the sheet bundle by the folding roller pair 113 and the conveyance direction of the sheet bundle by the saddle third roller pair 118 different and bending the conveyance path between the post-folding path guide 114 and the post-second roller path guide 116, the width (length in the second conveyance direction, length in the left-right direction of FIG. 2) of the sheet processing apparatus B can be reduced, and thus the apparatus can be miniaturized. In addition, by discharging the sheet bundle downward by the saddle third roller pair 118 with the folding roller conveyance direction 113c serving as the sheet conveyance direction of the saddle third roller pair 118 directed diagonally downward, the sheet bundle processed by the saddle portion B2 can be discharged to a position lower in the apparatus. As a result of this, the saddle discharge unit 131 to which the sheet bundle processed by the saddle portion B2 is discharged can be disposed in a lower portion of the apparatus, and thus the amount by which the first tray 49 positioned above the saddle discharge unit 131 can be moved down can be increased. As a result of this, the sheet stacking amount of the first tray 49 can be increased. To be noted, in the case where “horizontal”, “vertical”, “parallel”, and the like are mentioned in the layout of the conveyance path guides for the sheet or sheet bundle and the conveyance direction of the sheet or sheet bundle, cases where an angle is formed with respect to the horizontal direction, the vertical direction, or the parallel direction due to the tolerance or the like are also included.

### Details of Square Back Processing Portion

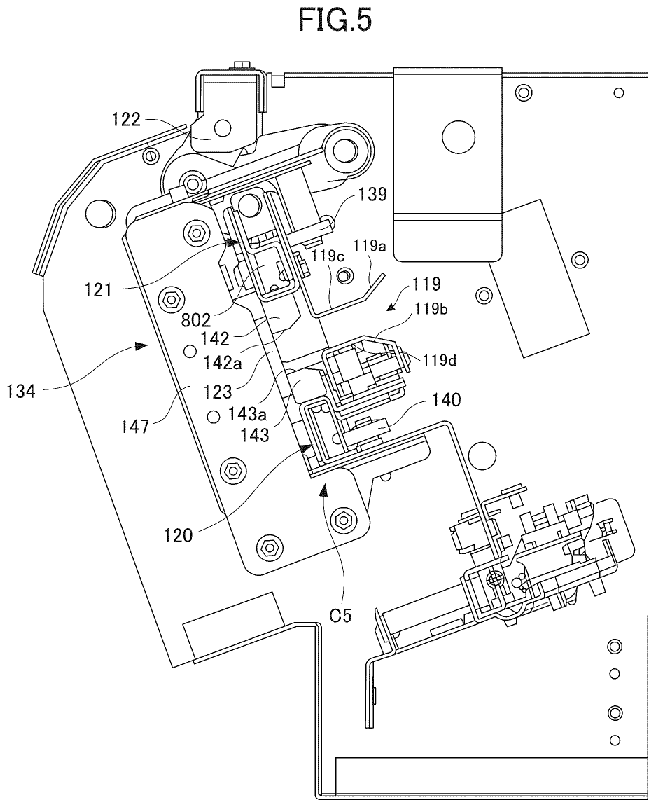

The square back processing portion C2 will be described by using FIGS. 5 to 10 with reference to FIGS. 2 and 4. As described above, the square back processing unit 134 including the lower clamp unit 120 and the upper clamp unit 121 serving as a pair of clamp portions and the pressing roller 123 is provided. A clamping mechanism C5 including the lower clamp unit 120 and the upper clamp unit 121 includes a pre-clamp guide 119 as illustrated in FIG. 5. The pre-clamp guide 119 is disposed at a position downstream of the saddle third roller pair 118 in the conveyance direction and is disposed along a direction bent downward in the vertical direction with respect to the saddle third roller conveyance direction 118c, and guides the conveyance of the sheet bundle.

The pre-clamp guide 119 includes a pre-clamp upper guide portion 119a serving as a first guide portion that guides the upper surface of the sheet bundle, and a pre-clamp lower guide portion 119b serving as a second guide portion that guides the lower surface of the sheet bundle. The pre-clamp upper guide portion 119a and the pre-clamp lower guide portion 119b are disposed at positions apart from a line centered on the saddle third roller conveyance direction 118c by a distance larger than a half of the maximum thickness of the sheet bundle that can be passed through the apparatus (the thickness of the sheet bundle after performing the half-folding process on the sheet bundle of the maximum thickness that can be conveyed in the apparatus). That is, the distance between the pre-clamp upper guide portion 119a and the pre-clamp lower guide portion 119b is larger than the maximum thickness of the sheet bundle that can be processed by the sheet processing apparatus B (maximum thickness of the sheet bundle that can be subjected to the half-folding process by the half-folding processing mechanism C1). To be noted, at least one of the pre-clamp upper guide portion 119a and the pre-clamp lower guide portion 119b may be omitted.

The lower clamp unit 120 and the upper clamp unit 121 serving as a pair of clamp units relatively move along the thickness direction of the sheet bundle conveyed by the saddle third roller pair 118, and thus nips the sheet bundle and release the nipping. That is, the lower clamp unit 120 and the upper clamp unit 121 are relatively movable to a first position where the sheet bundle conveyed from the saddle third roller pair 118 can be received and a second position where the sheet bundle is nipped. Further, the lower clamp unit 120 and the upper clamp unit 121 move from the first position to the second position and thus nip part of the sheet bundle from both sides in the thickness direction of the sheet bundle.

In the case of the present embodiment, the upper clamp unit 121 serving as a first clamp portion is movable, and the lower clamp unit 120 serving as a second clamp portion is fixed. That is, the upper clamp unit 121 moves in a direction to approach the lower clamp unit 120, and thus the sheet bundle is nipped. To be noted, a configuration in which the upper clamp unit 121 is fixed and the lower clamp unit 120 is movable may be employed, and a configuration in which both of these are movable may be employed. In either case, an upper clamping surface (upper clamping pressing portion) 142 of the upper clamp unit 121 that is a surface opposing the lower clamp unit 120 and a lower clamping surface (lower clamping pressing portion) 143 of the lower clamp unit 120 that is a surface opposing the upper clamp unit 121 nip the sheet bundle (see FIGS. 5 and 11A to 11D).

The lower clamping surface 143 of the lower clamp unit 120 and the upper clamping surface 142 of the upper clamp unit 121 are respectively parallel to the pre-clamp upper guide portion 119a and the pre-clamp lower guide portion 119b and are disposed downstream of the pre-clamp guide 119 in the conveyance direction of the sheet bundle. Further, the sheet bundle conveyed while being guided by the pre-clamp guide 119 is conveyed by a predetermined amount while further being guided by the upper clamping surface 142 and the lower clamping surface 143. To be noted, the pre-clamp lower guide portion 119b and the pre-clamp upper guide portion 119a are respectively fixed to the lower clamp unit 120 and the upper clamp unit 121. In the present embodiment, the pre-clamp upper guide portion 119a moves approximately in the vertical direction (thickness direction of the sheet bundle) together with the upper clamp unit 121.

### Square Back Processing Unit

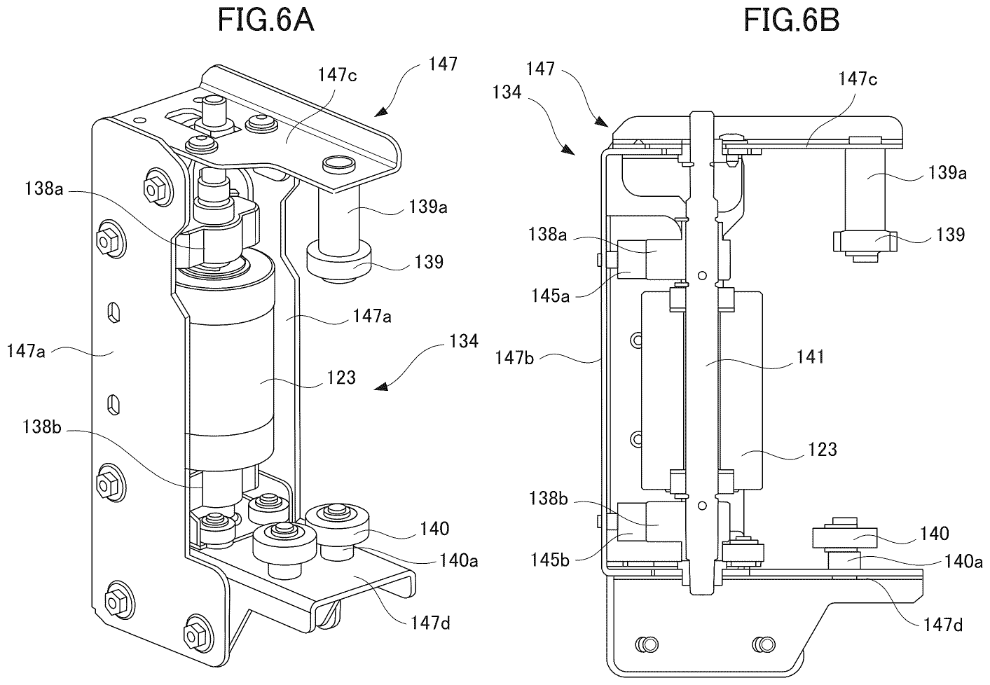

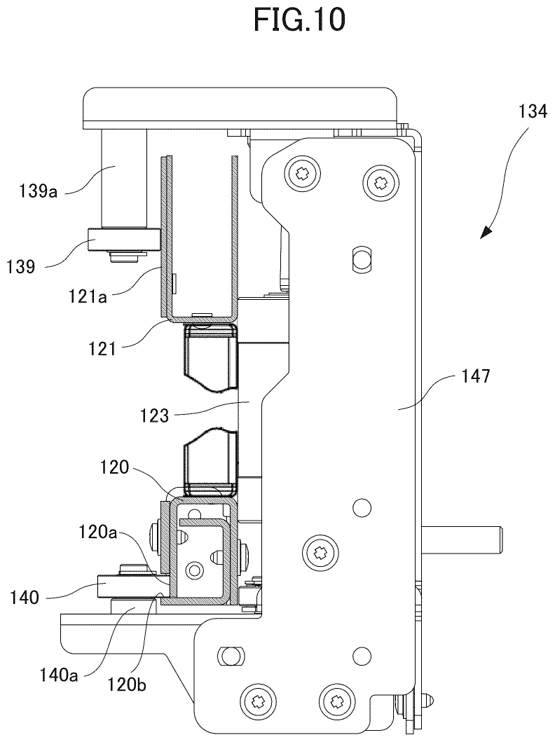

Next, an inner configuration of the square back processing unit 134 will be described with reference to FIGS. 5 to 10. The square back processing unit 134 includes, as elements for supporting and moving the pressing roller (square back processing roller) 123, a unit frame 147, roller pressurizing portions 138a and 138b, pressurizing springs 145a and 145b, an upper movement regulating portion 139, and a lower movement regulating portion 140. The pressing roller 123 is disposed such that the outer peripheral surface thereof is in contact with a downstream end surface of each of the lower clamp unit 120 and the upper clamp unit 121 as illustrated in FIGS. 5 and 10. In addition, a roller shaft 141 is disposed on the radially inner side of the pressing roller 123, and the pressing roller 123 is rotatable with respect to the roller shaft 141 as illustrated in FIG. 6B.

As illustrated in FIGS. 6A and 6B, the unit frame 147 includes a pair of side plates 147a disposed on the two sides of the pressing roller 123, a rear side plate 147b disposed on the left side of the downstream side (FIG. 6B) in the first conveyance direction of the pressing roller 123, and an upper side plate 147c and a lower side plate 147d that are provided on the two sides of the pressing roller 123 in the rotational axis direction so as to be bent from two end portions of the rear side plate 147b. The unit frame 147 is configured in this manner, and thus accommodates the pressing roller 123 in a space enclosed by the side plates and exposes the pressing roller 123 on the upstream side in the first conveyance direction.

In the present embodiment, the rear side plate 147b, the upper side plate 147c, and the lower side plate 147d are formed integrally, and has an approximate C shape in section view as illustrated in FIG. 6B. To be noted, these may be formed as separate members, or may be formed integrally with the pair of side plates 147a. The two end portions of the roller shaft 141 of the pressing roller 123 are respectively rotatably supported by the upper side plate 147c and the lower side plate 147d. In addition, the upper side plate 147c and the lower side plate 147d are provided to extend upstream of the pressing roller 123 in the first conveyance direction, and the upper movement regulating portion 139 and the lower movement regulating portion 140 are respectively supported at distal end portions of the upper side plate 147c and the lower side plate 147d.

That is, the upper movement regulating portion 139 is provided at a distal end portion of a support shaft 139a fixed to the upper side plate 147c and provided to extend downward from the upper side plate 147c. In addition, the lower movement regulating portion 140 is provided at a distal end portion of a support shaft 140a fixed to the lower side plate 147d and provided to extend upward from the lower side plate 147d. In addition, the upper movement regulating portion 139 is a roller rotatably provided at the distal end portion of the support shaft 139a, and the lower movement regulating portion 140 is a roller rotatably provided at the distal end portion of the support shaft 140a. To be noted, although two lower movement regulating portions 140 are provided side by side in the present embodiment, the number of the lower movement regulating portions 140 may be one. In addition, two upper movement regulating portions 139 may be also provided. The upper movement regulating portion 139 and the lower movement regulating portion 140 are positioned on the respective sides of the pressing roller 123 in the rotational axis direction of the roller shaft 141.

The roller pressurizing portions 138a and 138b are each coupled to the roller shaft 141 from the outside in the roller thickness direction of the pressing roller 123 and from the downstream side in the conveyance direction. Pressurizing springs 145a and 145b are disposed between the roller pressurizing portions 138a and 138b and the rear side plate 147b of the unit frame 147, and the roller shaft 141 is urged by the pressurizing springs 145a and 145b. The roller shaft 141 is configured to be movable in the conveyance direction, and therefore the pressurizing force by which the pressing roller 123 pressurizes the spine of the sheet bundle by the urging force of the pressurizing springs 145a and 145b changes in accordance with the change in the protruding amount of the spine of the sheet bundle from the lower clamp unit 120 and the upper clamp unit 121 that will be described later.

In addition, the pressing roller 123 is urged by the pressurizing springs 145a and 145b via the roller shaft 141, and is therefore pressurized by the lower clamp unit 120 and the upper clamp unit 121. In contrast, the upper movement regulating portion 139 and the lower movement regulating portion 140 are disposed on the opposite side to the pressing roller 123 across the lower clamp unit 120 and the upper clamp unit 121 so as to respectively oppose the lower clamp unit 120 and the upper clamp unit 121 (FIG. 5). That is, the upper movement regulating portion 139 and the lower movement regulating portion 140 are disposed on the upstream side of the lower clamp unit 120 and the upper clamp unit 121 in the conveyance direction of the sheet bundle (first conveyance direction) so as to respectively oppose the upper clamp unit 121 and the lower clamp unit 120.

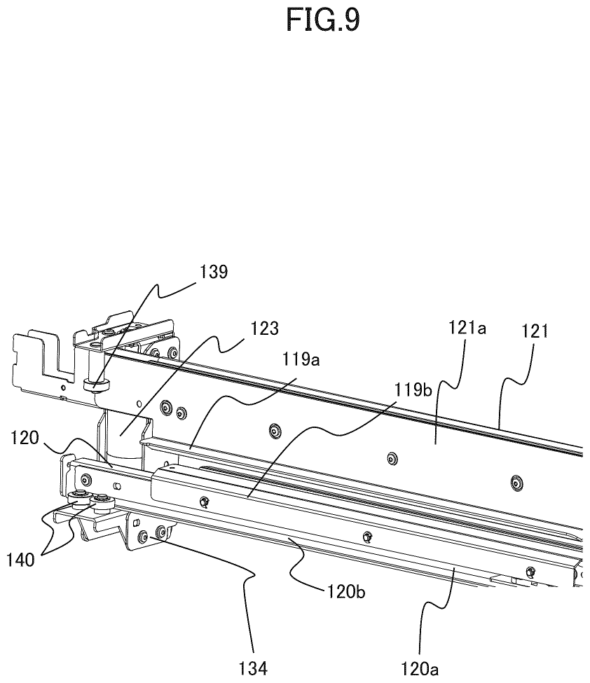

As illustrated in FIGS. 9 and 10, an end surface 120a on the upstream side of the lower clamp unit 120 is in contact with the lower movement regulating portion 140. In addition, an end surface 121a on the upstream side of the upper clamp unit 121 is in contact with the upper movement regulating portion 139. In the present embodiment, the lower movement regulating portion 140 and the upper movement regulating portion 139 are each a roller having a rotation shaft in a direction (up-down direction of FIG. 10, an approximately vertical direction in the present embodiment) orthogonal to the width direction of the sheet bundle and the conveyance direction of the sheet bundle, and respectively rotate in contact with the end surfaces 120a and 121a. As a result of this, upstream movement of the lower clamp unit 120 and the upper clamp unit 121 caused by the pressurizing force applied from the pressing roller 123 to the lower clamp unit 120 and the upper clamp unit 121 is restricted.

The conveyance amount of the sheet bundle conveyed by the saddle third roller pair 118 is counted by the square back process controller 345 when the leading end of the sheet bundle is detected by the saddle conveyance sensor 117 described above, and the sheet bundle is stopped after being conveyed by a predetermined conveyance amount. Specifically, as illustrated in FIG. 11A that will be described later, the sheet bundle is stopped in a state in which the spine of the sheet bundle subjected to the half-folding protrudes downstream in the conveyance direction more than the upper clamp unit 121 and the lower clamp unit 120. In the present embodiment, in the square back process, the conveyance amount of the sheet bundle by the saddle third roller pair 118 is controlled, and thus the protruding amount of the spine of the sheet bundle from the upper clamp unit 121 and the lower clamp unit 120 is adjusted.

### Upper Clamp Unit and Lower Clamp Unit

The upper clamp unit 121 moves from a receiving position (first position) for receiving the sheet bundle to a clamp holding position (second position) for holding the sheet bundle, thus the sheet bundle is pressurized between the upper clamp unit 121 and the lower clamp unit 120, and the sheet bundle is held by the upper clamping surface 142 and the lower clamping surface 143. At this time, the leading end of the sheet bundle protrudes by a predetermined protruding amount P1 from respective end surfaces 120c and 121b on the downstream side of the lower clamp unit 120 and the upper clamp unit 121 after the clamp holding in the conveyance direction as illustrated in FIG. 11B.

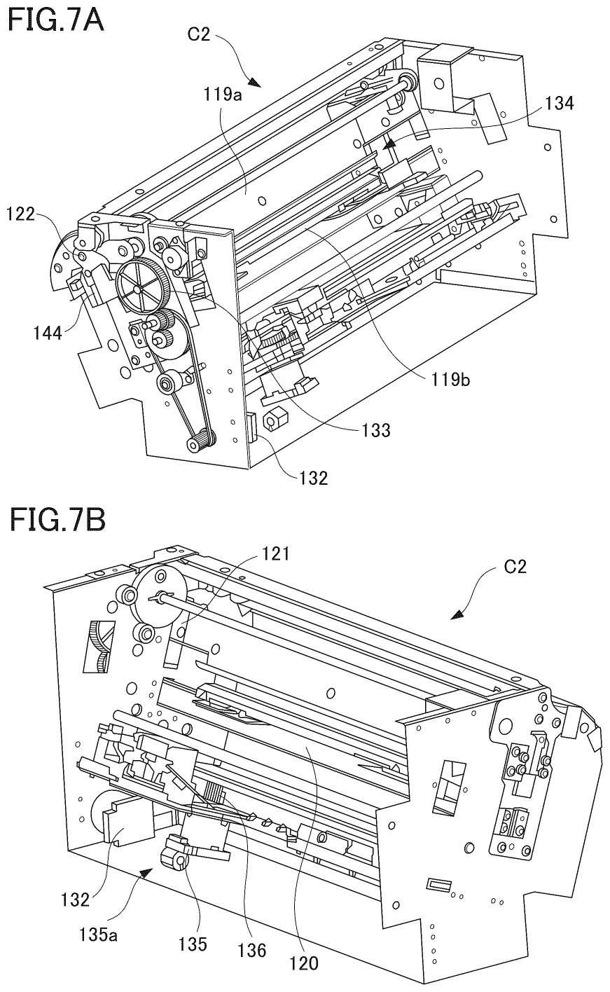

The upper clamp unit 121 operates by driving a clamp driving motor 132 (FIGS. 7A and 7B) by the square back process controller 345. As illustrated in FIGS. 7A and 7B, the square back processing portion C2 transmits a drive transmitted by a clamp driving train 133 constituted by a pulley, a belt, and a gear train further to a clamp driving link 122, and thus moves the upper clamp unit 121 connected to the clamp driving link 122 in the thickness direction of the sheet bundle. A plurality of clamp springs 144 that pressurize the sheet bundle are provided between the clamp driving link 122 and the upper clamp unit 121, and while the movement amount of the clamp driving link 122 remains constant, the contraction amount of the clamp spring 144 changes in accordance with the thickness of the sheet bundle, and thus the pressurizing force changes. The clamp holding position described above also changes in accordance with the thickness of the sheet bundle.

### Square Back Processing Portion

As illustrated in FIG. 11C that will be described later, the square back processing portion C performs the square back process on the sheet bundle held between the lower clamp unit 120 and the upper clamp unit 121 in a state of protruding from the end surfaces 120c and 121b by the predetermined protruding amount P1, by pressurizing the spine of the sheet bundle while moving, in the width direction of the sheet bundle in a scanning manner, the pressing roller 123 disposed on the downstream side in the conveyance direction.

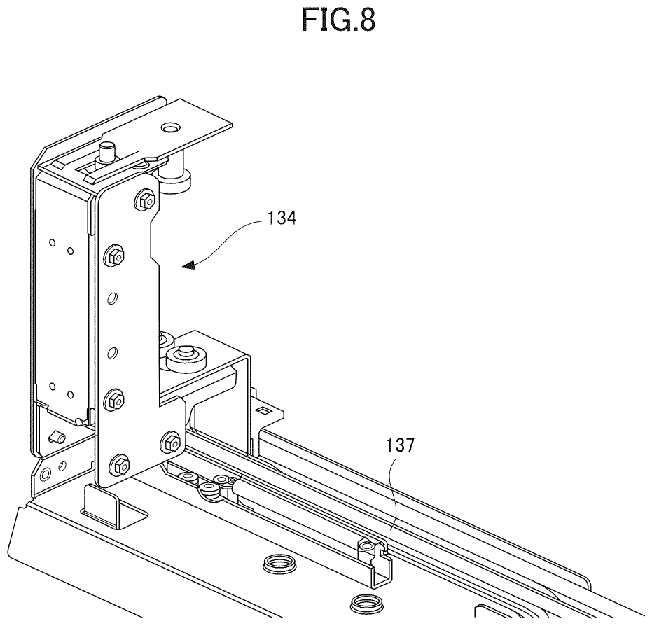

During the square back process, the pressing roller 123 is moved by operating a driving motor 135 (FIG. 7B) by the square back process controller 345. The pressing roller 123 is coupled to a driving belt 137 disposed in the width direction of the sheet bundle as illustrated in FIG. 8, and is movable in the width direction of the sheet bundle along a guide rail 120b illustrated in FIG. 9 that will be described later. The driving belt 137 rotates by receiving a driving force transmitted from the driving motor 135 via a driving train 136 (FIG. 7B) constituted by a gear train. As a result of this, the pressing roller 123 can be moved in a scanning manner in the width direction of the sheet bundle.

To be noted, the home position of the pressing roller 123 is provided on the front side and rear side of the sheet processing apparatus B. That is, after the square back process is performed on the first sheet bundle by moving the pressing roller 123 from the rear side to the front side, the square back process can be performed on the second sheet bundle by moving the pressing roller 123 from the front side to the rear side. An unillustrated sensor is provided at each home position of the pressing roller 123, and thus the position of the pressing roller 123 can be detected. To be noted, a configuration in which the home position is provided at only one of the front side and the rear side and the scanning movement of the pressing roller 123 in the width direction is performed only from the front side to the rear side or from the rear side to the front side may be employed. In the case where the home position is provided at only one of the front side and the rear side, for example, after performing the square back process on the first sheet bundle by moving the pressing roller 123 from the rear side to the front side, the pressing roller 123 may be returned from the front side to the rear side and the square back process may be performed also on the second sheet bundle by moving the pressing roller 123 from the rear side to the front side.

In addition, in one square back process, the pressing roller 123 is moved in one direction from the front side to the rear side or from the rear side to the front side, but the pressing roller 123 may be reciprocated in one square back process. For example, whether the pressing roller 123 is moved in one direction or reciprocated may be set in accordance with the number of sheets included in the sheet bundle or the type of the sheet. This setting may be automatically performed by the controller, or may be performed by an operator such as a user or a service worker. Further, whether the pressing roller 123 is moved in one direction or reciprocated may be arbitrarily settable by the operator in each square back process.

The lower clamp unit 120 includes the guide rail 120b formed along the width direction of the sheet bundle as illustrated in FIGS. 9 and 10. The lower movement regulating portion 140 moves along the guide rail 120b in engagement with the guide rail 120b when the pressing roller 123 moves in the width direction of the sheet bundle. The guide rail 120b is formed in an approximate C shape in section view by combining a plurality of members as illustrated in FIG. 10 such that part of the lower movement regulating portion 140 formed in a roller shape can enter the guide rail 120b. The lower surface of the radially outer side of the lower movement regulating portion 140 is engaged with the lower surface of the guide rail 120b, and the outer peripheral surface of the lower movement regulating portion 140 is in contact with the end surface 120a. As a result of this, the movement in the sheet bundle thickness direction is restricted when the pressing roller 123 moves. To be noted, the guide rail 120b may be a groove formed in one member provided on the upstream side of the lower clamp unit 120 in the conveyance direction.

After the square back process is completed, the pressing roller 123 is moved in the width direction and is thus retracted from the conveyance path of the sheet bundle by operating the driving motor 135 (FIG. 7B), and the upper clamp unit 121 is moved in a direction away from the sheet bundle (FIG. 11D that will be described later) by operating the clamp driving motor 132 (FIGS. 7A and 7B). As a result of this, the sheet bundle can be further conveyed downstream. To be noted, the sheet bundle can be also discharged without performing the square back process described above.

### Discharge Portion

As illustrated in FIG. 2, the sheet bundle having passed the saddle portion B2 is conveyed toward the saddle discharge guide 124 disposed further downstream of the pressing roller 123 in the first conveyance direction, by the saddle third roller pair 118. The saddle discharge guide 124 is supported to be swingable about a first fulcrum 124b including a rotation shaft parallel to the rotational axis of each roller of the saddle third roller pair 118. The first fulcrum 124b is positioned above an extension line of the conveyance direction (first conveyance direction, saddle third roller conveyance direction 118c) of the sheet bundle by the saddle third roller pair 118. Further, the saddle discharge guide 124 is disposed to hang down in the vertical direction from the first fulcrum 124b.

In addition, the saddle discharge guide 124 is formed such that the side surface thereof on the upstream side in the first conveyance direction is inclined upstream in the first conveyance direction from the first fulcrum 124b toward a middle portion 124a in the vertical direction. In addition, the side surface of the saddle discharge guide 124 on the upstream side in the first conveyance direction is inclined downstream in the first conveyance direction from the middle portion 124a toward the lower end in the vertical direction. That is, the side surface of the saddle discharge guide 124 on the upstream side in the first conveyance direction is formed such that the middle portion 124a in the vertical direction protrudes upstream in the first conveyance direction as compared with the other part. Further, in the side surface of the saddle discharge guide 124 on the upstream side in the first conveyance direction, a guide surface 124d is provided in a portion from the middle portion 124a to the lower end.

The guide surface 124d is positioned below an extension line obtained of the saddle third roller conveyance direction 118c, comes into contact with the sheet bundle conveyed by the saddle third roller pair 118, and guides the sheet bundle downward. The saddle discharge guide 124 is capable of pivoting about the first fulcrum 124b when the sheet bundle comes into contact with the guide surface 124d. To be noted, depending on the stiffness of the sheet bundle, there is a case where the sheet bundle does not come into contact with the guide surface 124d of the saddle discharge guide 124, and even in the case where the contact occurs, since the amount of the pivot changes depending on the stiffness, the saddle discharge guide 124 does not necessarily pivot.

In addition, a second fulcrum 124c is provided at a lower end portion of the saddle discharge guide 124, and a saddle discharge roller 125 that will be described later is coupled to the lower end portion of the saddle discharge guide 124 so as to be pivotable about the second fulcrum 124c. The second fulcrum 124c is positioned below the guide surface 124d, and includes a pivot shaft parallel to the pivot shaft of the first fulcrum 124b.

When the sheet bundle continues to be conveyed by the saddle third roller pair 118, the sheet bundle is passed onto a saddle discharge unit 131 disposed downstream of the square back processing unit 134 in the first conveyance direction and below the saddle discharge guide 124 in the vertical direction. The saddle discharge unit 131 includes a saddle discharge upstream belt 127, a saddle discharge upstream sensor 128, a saddle discharge downstream belt 129, and a saddle discharge downstream sensor 130.

The saddle discharge upstream belt 127 is positioned below the guide surface 124d of the saddle discharge guide 124, and guides and conveys the sheet bundle guided downward by the guide surface 124d further downstream. The saddle discharge upstream belt 127 is inclined downward in the vertical direction toward the downstream side in the conveyance direction. The saddle discharge downstream belt 129 serving as a sheet bundle discharge portion receives the sheet bundle conveyed from the saddle discharge upstream belt 127, and further guides and conveys the received sheet bundle downstream. The saddle discharge downstream belt 129 is inclined upward in the vertical direction toward the downstream side in the conveyance direction. Therefore, the sheet bundle guided to the saddle discharge upstream belt 127 by the guide surface 124d is conveyed by the saddle discharge upstream belt 127 in a direction inclined downward in the vertical direction, and is then conveyed by the saddle discharge downstream belt 129 in a direction inclined upward in the vertical direction.

In addition, the saddle discharge upstream sensor 128 that detects the sheet bundle on the upstream side is disposed on the upstream side in a conveyable region of the saddle discharge upstream belt 127, and the saddle discharge downstream sensor 130 that detects the sheet bundle on the downstream side is disposed on the upstream side in a conveyable region of the saddle discharge downstream belt 129.

The sheet bundle passed on to the saddle discharge unit 131 is guided and conveyed by the saddle discharge upstream belt 127 and the saddle discharge downstream belt 129, and is then stacked. The saddle discharge upstream belt 127 nips the sheet bundle at a nip point between the saddle discharge upstream belt 127 and the saddle discharge roller 125 described above on the downstream side in the conveyance direction. The sheet bundle present on the saddle discharge upstream belt 127 is configured to suppress opening on the opening portion side (fore edge side) at this nip point. The position of this nip point can change about a second fulcrum 124c in accordance with the thickness of the sheet bundle.

While the succeeding sheet bundle is processed, the preceding sheet bundle is conveyed upstream in the conveyance direction by the saddle discharge upstream belt 127, and is stopped after a predetermined conveyance amount since being detected by the saddle discharge upstream sensor 128 or the saddle discharge downstream sensor 130. The position where the preceding sheet bundle stops corresponds to a position where the opening on the opening portion side of the preceding sheet bundle can be suppressed at the nip point between the saddle discharge upstream belt 127 and the saddle discharge roller 125, and to a position where the succeeding sheet comes into contact with the upper surface of the preceding sheet bundle when being discharged. That is, in the present embodiment, the succeeding sheet bundle is stacked on the preceding sheet bundle such that the sheet bundles partially overlap each other in the saddle discharge unit 131.

As described above, the saddle discharge unit 131 discharges the succeeding sheet bundle onto the upper surface of the preceding sheet bundle without entering the opening portion of the preceding sheet bundle, and thus the sheet bundles are stably stacked without occurrence of a failure such as getting caught by the preceding sheet bundle, getting curled against the preceding sheet bundle, or pushing out the preceding sheet bundle. That is, by appropriately changing the conveyance amount described above in accordance with the size of the sheet bundle, the succeeding sheet bundle can be stably stacked on the preceding sheet bundle.

The saddle discharge portion 126 is disposed at a position downstream of the saddle discharge guide 124 in the first conveyance direction and between the saddle discharge upstream belt 127 and the saddle discharge downstream belt 129. The sheet bundle conveyed to the saddle discharge unit 131 passes through the saddle discharge portion 126 to be discharged to the outside of the sheet processing apparatus B, and thus the user can easily access the discharged sheet bundle.

To be noted, in the case where another apparatus is present on the downstream side of the saddle discharge unit 131, the sheet bundle can be passed on to the downstream apparatus by continuing the conveyance without the stacking. In addition, in the present embodiment, a discharge cover 151 serving as a cover member is provided on the outside of the saddle discharge portion 126. The discharge cover 151 is disposed so as not to interrupt discharge of the sheet bundle from the saddle discharge portion 126 and such that an operator such as a user cannot access the inside of the apparatus through the saddle discharge portion 126.

### Control of Square Back Process

Next, the control of the square back process of the present embodiment will be described with reference to FIGS. 11A to 11D. As described above, the square back processing portion C2 performs the square back process of forming a corner on the spine of the sheet bundle subjected to the saddle binding process and the half-folding process. A square back processing mode that is a control mode for performing the square back process will be described below. In addition, the half-folding controller 344 illustrated in FIG. 3 controls each conveyance roller pair of the folding roller pair 113, the saddle second roller pair 115, and the saddle third roller pair 118 by the same driving.

The square back processing mode will be described. The square back processing mode is a mode in which a corner is formed on the spine of a sheet bundle Sb by pressing the pressing roller 123 against the spine of the sheet bundle Sb. The half-folding controller 344 conveys the sheet bundle Sb subjected to the half-folding to the gap between the upper clamp unit 121 and the lower clamp unit 120 in the separated state in response to detection of the leading end of the sheet bundle Sb by the saddle conveyance sensor 117. Then, as illustrated in FIG. 11A, the half-folding controller 344 stops the conveyance of the sheet bundle Sb in a state in which a spine Ssp of the sheet bundle Sb protrudes further downstream in the first conveyance direction than the end surfaces 121b and 120c on the downstream side in the first conveyance direction of the upper clamp unit 121 and the lower clamp unit 120.

In this state, the square back process controller 345 drives the clamp driving motor 132 (FIGS. 7A and 7B) and thus moves the upper clamp unit 121 toward the lower clamp unit 120, and as illustrated in FIG. 11B, the sheet bundle Sb is nipped by the upper clamp unit 121 and the lower clamp unit 120. At this time, the spine Ssp of the sheet bundle Sb protrudes further downstream than the end surfaces 121b and 120c on the downstream side in the first conveyance direction of the upper clamp unit 121 and the lower clamp unit 120 by P1.

Next, the square back process controller 345 operates the driving motor 135 (FIG. 7B), and thus moves the pressing roller 123 in the width direction of the sheet bundle Sb. At this time, as illustrated in FIG. 11C, the pressing roller 123 moves in the width direction while pressurizing the spine Ssp of the sheet bundle Sb, and thus the square back process is performed on the spine Ssp of the sheet bundle Sb. Then, as illustrated in FIG. 11D, the square back process controller 345 drives the clamp driving motor 132 (FIGS. 7A and 7B), thus separates the upper clamp unit 121 from the lower clamp unit 120, and releases the nipping of the sheet bundle Sb. In the first mode, the square back process is finished here, and the discharge operation of the sheet bundle Sb described above is performed.

### Draw-Out of Saddle Portion B2

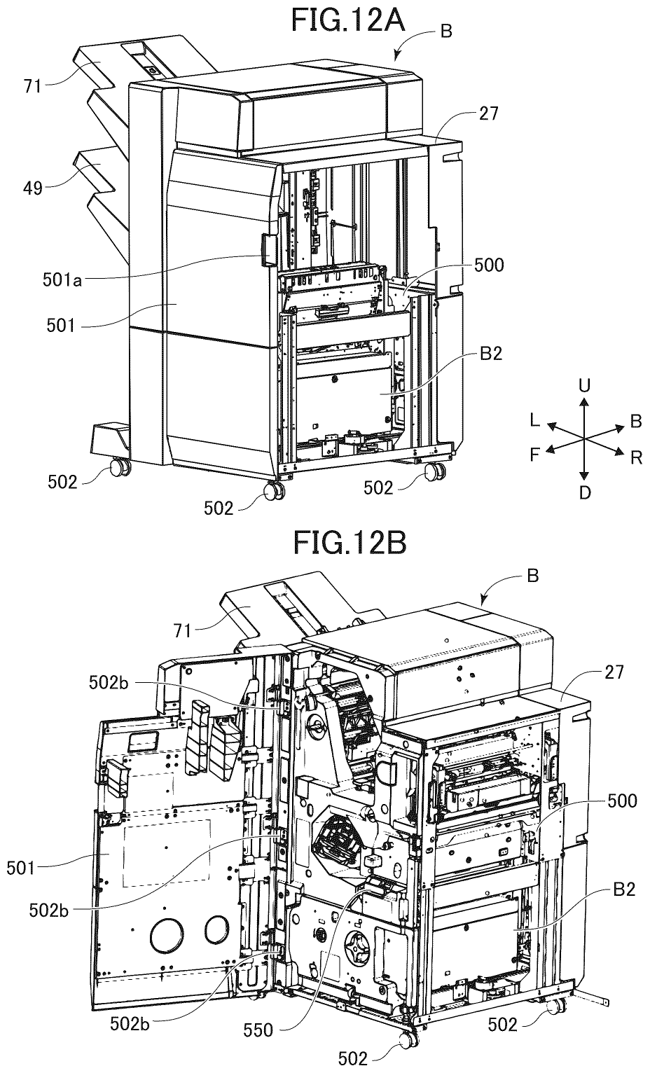

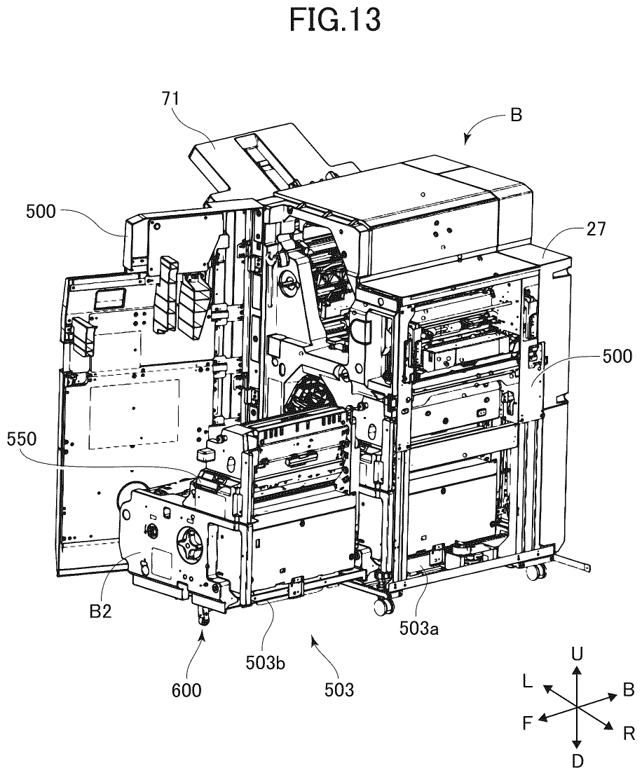

Next, an operation performed when performing maintenance of the saddle portion B2 serving as a processing unit will be described with reference to FIGS. 12A to 13. Examples of the maintenance mentioned herein include a case where a conveyance abnormality of the sheet has occurred and the user performs jam removal of removing the sheet in the unit, a case where the user or a service worker replaces a part, and the like. FIGS. 12A to 13 are each a perspective view of the sheet processing apparatus B as viewed from the side (upstream side in the sheet conveyance direction) on which the sheet processing apparatus B is coupled to the image forming apparatus A. FIG. 12A illustrates a state in which a front cover 501 of the sheet processing apparatus B is closed, FIG. 12B illustrates a state in which the front cover 501 of the sheet processing apparatus B is open, and FIG. 13 illustrates a state in which the saddle portion B2 of the sheet processing apparatus B has been drawn out.

The saddle portion B2 is disposed to be capable of being drawn out from the housing 27 serving as a casing and being inserted to an attached position in the housing 27. In the present embodiment, the saddle portion B2 is configured to be drawn out from the front side (F side) in the front-rear direction (F-B direction) that is a direction orthogonal to the sheet conveyance direction in the sheet processing apparatus B. To be noted, in the description below, a sheet conveyance direction (may be simply referred to as a “conveyance direction”) refers to a conveyance direction of the sheet in the conveyance path 28 (left-right direction in FIG. 2). In addition, as indicated by the coordinate axes of FIG. 12A, the U side is the upper side in the vertical direction, and the D side is the lower side in the vertical direction. In addition, the F side is the front side of the sheet processing apparatus B, and the B side is the back side (also referred to as the rear side) of the sheet processing apparatus B. Further, the L side is the left side of the sheet processing apparatus B as viewed from the front side, and is the downstream side in the sheet conveyance direction. The R side is the right side of the sheet processing apparatus B as viewed from the front side, and is the upstream side in the sheet conveyance direction.

The sheet processing apparatus B is provided with the front cover 501 (opening/closing door) constituting part of the exterior of the apparatus. The housing 27 serving as a casing includes a body frame 500, the front cover 501, and other exterior covers and the like. Casters 502 are respectively provided at four positions on the lower surface of the body frame 500. The four casters 502 serving as main support portions support the housing 27 with respect to the installation surface. As a result of providing the casters 502 in this manner, the sheet processing apparatus B can be easily moved by the user or the service worker when moving or installing the sheet processing apparatus B to or at a desired position.

The front cover 501 is provided with a handle 501a at an end portion on the R side as illustrated in FIG. 12A. In addition, the front cover 501 is pivotably supported with respect to the body frame 500 as illustrated in FIG. 12B, at three positions via hinges 502b in the illustrated example. The rotational axis direction of the hinges 502b is the vertical direction, and the end portion of the front cover 501 on the L side is pivotably supported about the rotational axis of the hinges 502b. In the case of performing the maintenance of the saddle portion B2, the user or the service worker first hooks the hand on the handle 501a of the front cover 501 in the state of FIG. 12A and pulls to the F side, and thus opens the front cover 501 from the R side to the L side. At this time, the front cover 501 pivots about the hinges 502b, and an operation lever 550 to be operated when drawing out the saddle portion B2 is exposed as illustrated in FIG. 12B. To be noted, the direction in which the front cover 501 is opened may be reversed from that described above. In addition, the front cover 501 may be formed in a double door form.

When the operation lever 550 is operated by the user or the service worker, an unillustrated lock between the saddle portion B2 and the body frame 500 is released, and it becomes possible to draw out the saddle portion B2 from the inside of the housing 27 to the F side (front side) as illustrated in FIG. 13. To be noted, by pushing the drawn-out saddle portion B2 to the B side (rear side), the saddle portion B2 is inserted into the housing 27 to the attached position, and thus the saddle portion B2 is locked with respect to the body frame 500 by an unillustrated lock portion.

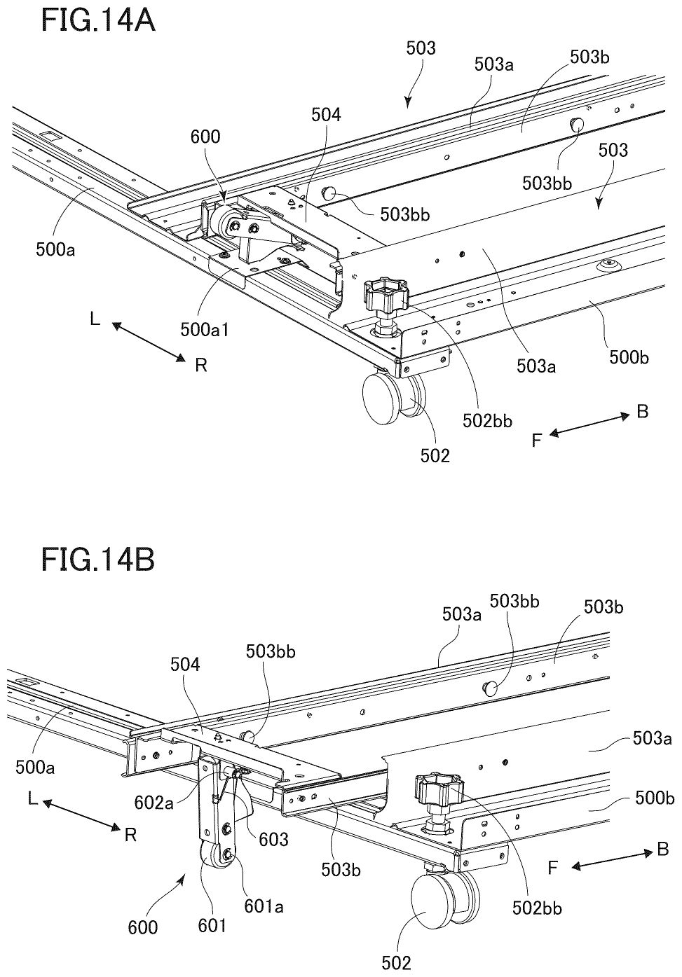

The saddle portion B2 is supported with respect to the body frame 500 via a rail portion 503. The rail portion 503 guides the saddle portion B2 such that the saddle portion B2 can be drawn out from and inserted into the inside body frame 500 of the housing 27. The rail portion 503 configured in this manner includes a fixed rail 503a fixed to the body frame 500, and a slide rail 503b slidable in the F-B direction (front-rear direction) with respect to the fixed rail 503a. Although the rail portion 503 supporting the R side of the saddle portion B2 is illustrated in FIG. 13, a similar rail portion 503 (see FIGS. 14A and 14B described later) is also disposed on the L side. The rail portions 503 configured in this manner guide the saddle portion B2 such that the saddle portion B2 can be drawn out from and inserted into the inside of the housing 27. That is, the saddle portion B2 is supported by and fixed to the slide rails 503b, and can be drawn out from and inserted into the body frame 500 of the housing 27 as a result of the slide rails 503b sliding in the F-B direction with respect to the fixed rails 503a.

As illustrated in FIG. 12B, the saddle portion B2 is positioned at the attached position in a state in which the saddle portion B2 is positioned inside the body frame 500. In contrast, as illustrated in FIG. 13, a position in which the saddle portion B2 is outside the housing 27 is a drawn-out position of the saddle portion B2, which serves as a maintenance position where a sheet is removed in the case where a jam of sheet has occurred in the saddle portion B2, or where part is replaced.

To be noted, the attached position of FIG. 12B does not have to be a position where all the elements constituting the saddle portion B2 are inside the body frame 500 including struts thereof as long as the front cover 501 can be closed. For example, a state in which part of the operation lever 550, a cover member, or the like projects more to the front side than the body frame 500 is acceptable, and in this case, for example, the part projecting to the front side of the body frame 500 is positioned within a recess portion or the like formed inside the front cover 501.

In addition, the drawn-out position illustrated in FIG. 13 does not have to be a position where all the elements constituting the saddle portion B2 are outside the body frame 500 as long as the user or the service worker can access the saddle portion B2. For example, parts of the saddle portion B2 disposed on the B side such as cables and various driving mechanisms may be positioned inside the body frame 500.

In addition, the drawn-out position may be configured as two positions including a maintenance position for the user to perform jam removal and a maintenance position for the service worker to perform maintenance of each unit or the like. For example, the saddle portion B2 may be configured to be capable of being further drawn out to the F side such that the service worker can also access electric parts disposed on the B side (rear side) of the apparatus. As a result of this, no unnecessary draw-out and insertion operation of the saddle portion B2 occurs at the time of maintenance by the user, and the service worker can easily perform the work at the time of maintenance by the service worker, which improves the usability of the apparatus. For example, a configuration in which the slide rail 503b can be drawn out to two positions with respect to the fixed rail 503a and the saddle portion B2 is drawn out further than the position of FIG. 13 (maintenance position for the user) at the time of maintenance by the service worker is employed.

In addition, although the rail portion 503 is provided on the lower side of the saddle portion B2 in the present embodiment, the rail portion 503 supporting the saddle portion B2 may be provided at a different position as long as the maintenance is not interrupted. For example, the rail portion 503 that guides the saddle portion B2 may be provided on the upper side. To be noted, the support stiffness of the rail portion 503 for supporting the saddle portion B2, which is a heavy object, is more easily secured in the case where the rail portion 503 is provided on the lower side than in the case where the rail portion 503 is provided on the upper side. In addition, in the present embodiment, part of a saddle stacking tray 150 on which a sheet from the saddle path 32 is conveyed projects at the upper portion of the saddle portion B2 (see FIG. 2). Therefore, the width of the saddle portion B2 in the L-R direction (left-right direction) is smaller at the upper portion than at the lower portion, it is more difficult to dispose the rail portion 503 on the upper side of the saddle portion B2, and even if the rail portion 503 is disposed on the upper side, it is difficult to perform jam removal at the upper portion of the saddle portion B2. In contrast, in the case where the rail portion 503 is disposed on the lower side of the saddle portion B2 as in the present embodiment, the saddle portion B2 can be easily accessed from above, and therefore the jam having occurred in the saddle portion B2 can be easily removed.

### Support Leg Portion

Here, in the case where the saddle portion B2 is drawn out to the F side with respect to the body frame 500 as described above, the position of the center of gravity of the sheet processing apparatus B is displaced to the F side as compared with the state in which the saddle portion B2 is attached to the inside of the body frame 500. Therefore, there is a possibility that the apparatus is inclined to the front side when the saddle portion B2 is drawn out more. In the case where the saddle portion B2 is heavy, a larger load acts on the on the rail portion 503, which can cause deformation of the body frame 500 and the like. Therefore, in the present embodiment, a support leg portion 600 serving as a support portion that supports the saddle portion B2 is provided for suppressing occurrence of inclination of the apparatus when drawing out the saddle portion B2.

In addition, if the casters 502 for moving the entirety of the sheet processing apparatus B are provided separately from a caster 601 provided on the saddle portion B2 for assisting the draw-out operation of the saddle portion B2 as will be described later, there is a possibility that, when moving the entirety of the apparatus by using the casters 502, particularly in the case where the installation surface such as the floor is uneven, the caster 601 abuts the uneven portion of the floor surface or the like and interrupts the movement of the apparatus itself, leading to deterioration of the usability. Therefore, in the present embodiment, the support leg portion 600 is moved from a support position to an accommodation position in accordance with the operation of inserting the saddle portion B2 into the sheet processing apparatus B. The support position is a position where the support leg portion 600 is positioned for supporting the saddle portion B2 drawn out from the sheet processing apparatus B with respect to the installation surface on which the sheet processing apparatus B is installed. The accommodation position is a position where the support leg portion 600 is positioned in a state in which the saddle portion B2 is inserted in the sheet processing apparatus B. The support leg portion 600 will be described below with reference to FIGS. 14A to 20F.

FIG. 14A is a perspective view of the vicinity of the support leg portion 600 in a state in which the saddle portion B2 is accommodated inside the body frame 500. FIG. 14B is a perspective view of the vicinity of the support leg portion 600 in a state in which the saddle portion B2 has been drawn out from the body frame 500. To be noted in FIGS. 14A and 14B, illustration of the saddle portion B2 is omitted such that the relationship between the support leg portion 600 and the rail portion 503 is easily understandable.

The body frame 500 is constituted by a combination of a plurality of stays, and in FIGS. 14A and 14B, the lower portion of the front-right side of the body frame 500 is constituted by a front lower stay 500a disposed in the L-R direction at the lower portion on the F side and a right lower stay 500b disposed in the F-B direction at the lower portion on the R side. The rail portion 503 supporting the saddle portion B2 is disposed to extend from the front lower stay 500a to a rear lower stay (not illustrated) similarly disposed at a lower portion on the B side, and moves in the F-B direction between the right lower stay 500b and a left lower stay (not illustrated) similarly disposed at the lower portion on the L side. Although a configuration of the lower portion on the right-front side will be described below, the configuration of the lower portion of the body frame 500 is basically the same for all the four corners.

The F-side end portion of the right lower stay 500b is disposed on the upper surface of the R-side end portion of the front lower stay 500a, and these end portions are fixed to each other. Then, an adjustment handle 502bb is provided at a position on the side (upper side) opposite to the caster 502 through a hole formed at the F-side end portion of the right lower stay 500b in a state in which the caster 502 is fixed to the R-side end portion of the front lower stay 500a. The height of the caster 502 with respect to the front lower stay 500a can be adjusted by rotating the adjustment handle 502bb. As a result of this, even in the case where the installation surface on which the sheet processing apparatus B is installed such as a floor varies, the height of the sheet processing apparatus B and the height of the image forming apparatus A can be easily matched by adjusting the height of each of the four casters 502 provided on the lower surface of the body frame 500.

As illustrated in FIG. 12B described above, in a state in which the saddle portion B2 is at the attached position, the support leg portion 600 is positioned between the front lower stay 500a and a rail stay 504 provided between the pair of rail portions 503 as illustrated in FIG. 14A. The rail stay 504 is provided on the F side, and the two ends in the L-R direction of the rail stay 504 on the F side are respectively fixed to the pair of slide rails 503b so as to extend between the pair of slide rails 503b. The saddle portion B2 is supported by the rail stay 504 in a state in which the position thereof in the F-B direction is determined by a plurality of positioning members 503bb provided on the slide rails 503b of the rail portions 503. Therefore, the saddle portion B2 is movable in the F-B direction along the fixed rails 503a together with the pair of slide rails 503b and the rail stay 504.

The support leg portion 600 is movable to an accommodation position (FIG. 14A) where the support leg portion 600 is positioned in a state in which the saddle portion B2 is inserted in the housing 27, and a support position (FIG. 14B) for supporting the saddle portion B2 with respect to the installation surface on which the sheet processing apparatus B is installed in a state in which the saddle portion B2 has been drawn out from the inside of the housing 27. In the present embodiment, the support leg portion 600 is pivotable about a pivot shaft 602a between the accommodation position and the support position. Specifically, the support leg portion 600 is supported to be pivotable about the pivot shaft 602a with respect to the rail stay 504 serving as a rail-side support portion provided on the rail portions 503.

In addition, the support leg portion 600 is positioned between the front lower stay 500a and the rail stay 504 as illustrated in FIG. 14A in a state in which the saddle portion B2 is positioned at the attached position. This position is the accommodation position of the support leg portion 600. In the present embodiment, the support leg portion 600 pivots from the accommodation position illustrated in FIG. 14A to the support position illustrated in FIG. 14B by being urged by a spring 603 that will be described later in accordance with the movement of the saddle portion B2 from the attached position to the drawn-out position. In addition, part of the support leg portion 600 abuts part of the sheet processing apparatus B in accordance with the movement of the saddle portion B2 from the drawn-out position to the attached position, thus a locked state described later is cancelled, and the support leg portion 600 pivots from the support position illustrated in FIG. 14B to the accommodation position illustrated in FIG. 14A. That is, the support leg portion 600 moves from the accommodation position to the support position in an interlocked manner with an operation of drawing out the saddle portion B2, and moves from the support position to the accommodation position in an interlocked manner with the insertion operation of the saddle portion B2.

As illustrated in FIG. 14A, at the accommodation position, the caster 601 and the support leg portion 600 are positioned above the bottom surface of the sheet processing apparatus B supporting the casters 502. That is, at the accommodation position, the caster 601 and the support leg portion 600 are positioned inside the body frame 500 (above the front lower stay 500a). Since the support leg portion 600 is positioned inside the body frame 500 (above the bottom surface of the body frame 500 (bottom surface of the sheet processing apparatus B)) at the accommodation position, the support leg portion 600 does not interrupt the movement of the sheet processing apparatus B when moving the sheet processing apparatus B by the casters 502.

To be noted, the movement of the support leg portion 600 is not limited to the pivoting described above, and may be movement that is a combination of a plurality of slide movements such as a slide movement to the F side and a slide movement to the D side. For example, the support leg portion may be lifted up and moved to the accommodation position when moving the support leg portion from the support position to the accommodation position.

In addition, the support leg portion 600 supports the caster 601 serving as another caster (rotary member). The caster 601 is provided on the saddle portion B2, and comes into contact with the installation surface of the sheet processing apparatus B and supports the saddle portion B2 when the saddle portion B2 moves in the draw-out direction. The caster 601 configured in this manner is provided at a lower end portion of the support leg portion 600 in the vertical direction to be pivotable about a rotation shaft 601a parallel to the pivot shaft 602a. Specifically, the caster 601 is rotatably supported by a support metal plate 602 constituting the support leg portion 600 via the rotation shaft 601a. The rotation shaft 601a extends in the L-R direction (sheet conveyance direction, direction intersecting with the vertical direction and the front-rear direction).

The four casters 502 provided on the body frame 500 include a plurality of unillustrated pivot shafts, and thus can turn with respect to the body frame 500 in a range of 360° in addition to the rotation of the caster itself. This configuration is employed to facilitate handling of the apparatus when moving the sheet processing apparatus B to install the sheet processing apparatus B or the like. In contrast, the caster 601 provided on the support leg portion 600 is rotatable in only one direction (draw-out direction of the saddle portion B2, front-rear direction).

As a result of this, since the caster 601 moves only in the same direction as the draw-out direction of the saddle portion B2 when drawing out the saddle portion B2, the load of operation by the user drawing out the saddle portion B2 is suppressed, leading to good operability. In other words, deterioration of operability caused by the caster 601 directing in a direction different from the draw-out direction when drawing-out the saddle portion B2 is suppressed.

Meanwhile, when moving the sheet processing apparatus B, in the case where the caster 601 of the support leg portion 600 is in contact with the installation surface when the casters 502 rotate and move in a direction different from the direction in which the sheet processing apparatus B moves by the rotation of the caster 601, it is difficult to move the sheet processing apparatus B because the caster 601 rotates in only one direction. In contrast, in the present embodiment, since the support leg portion 600 is positioned at the accommodation position, the caster 601 of the support leg portion 600 that rotates in only one direction does not interrupt the movement of the sheet processing apparatus B when moving the sheet processing apparatus B by the casters 502, therefore the sheet processing apparatus B can be smoothly moved, leading to good operability.

In addition, even if the caster 601 is configured to be capable of turning similarly to the casters 502, in the case where the installation surface such as a floor is uneven, there is a possibility that when moving the sheet processing apparatus B, the caster 601 abuts the uneven portion and thus interrupts the movement of the apparatus. To be noted, in the present embodiment, since the support leg portion 600 is configured to be movable from the support position to the accommodation position, deterioration of the usability can be suppressed without interrupting the movement of the apparatus itself.

As described above, also in the case where the caster 601 supporting the movement of the saddle portion B2 in the draw-out direction is provided as in the present embodiment, deterioration of the usability can be suppressed without interrupting the movement of the sheet processing apparatus B itself. To be noted, examples of the movement of the sheet processing apparatus B include movement in the case of installing the sheet processing apparatus B and movement in the case of moving the sheet processing apparatus B away from the image forming apparatus A due to conveyance failure of the sheet or the like.

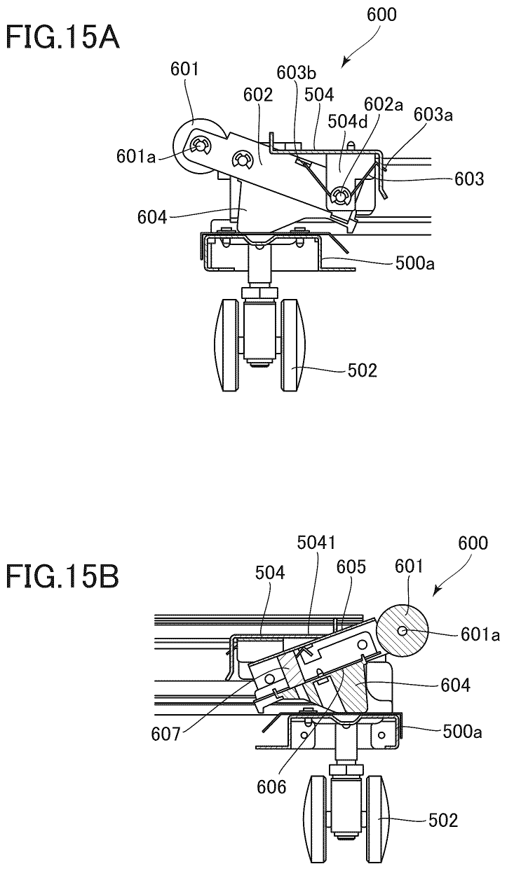

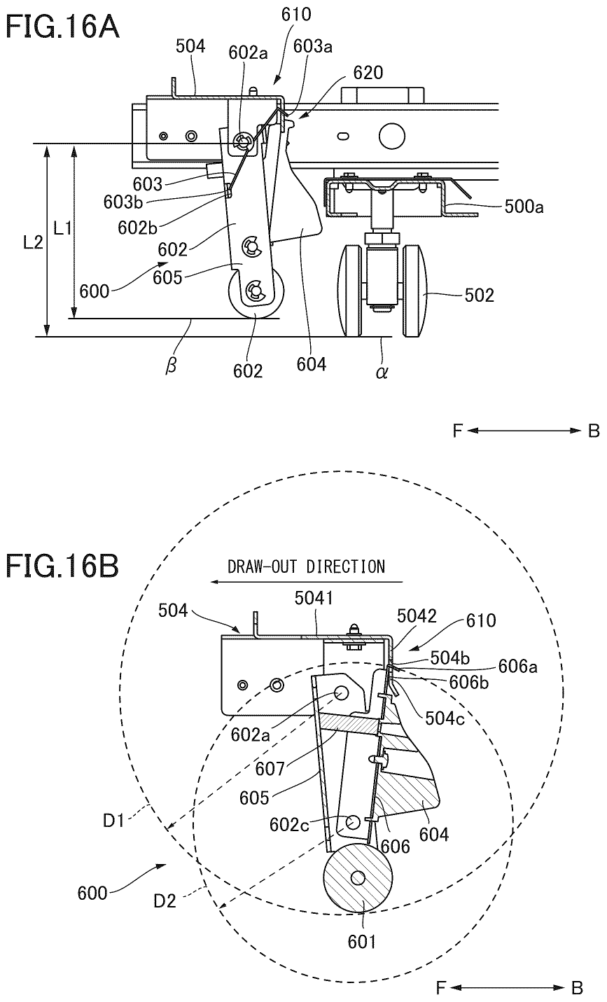

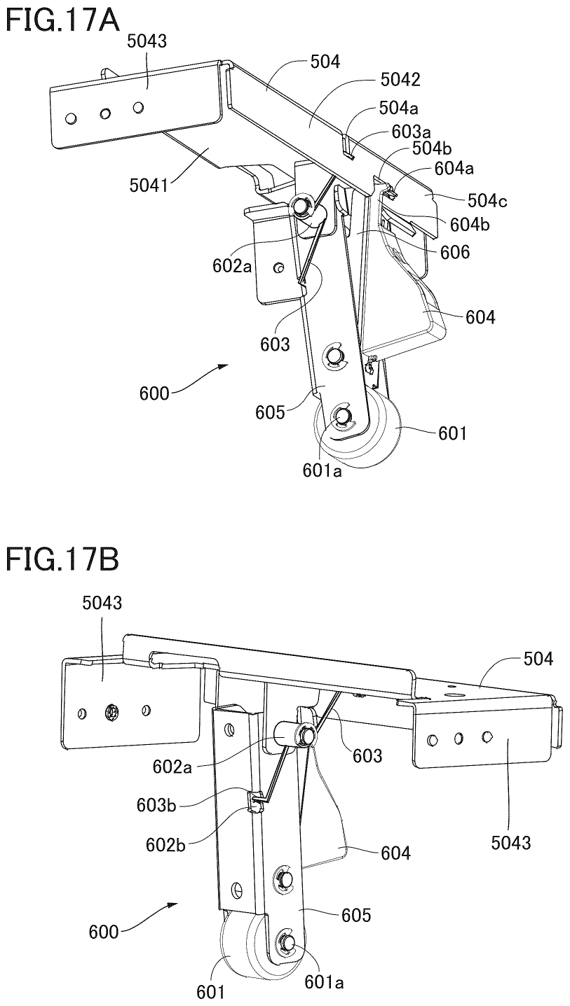

Next, the configuration of the support leg portion 600 will be described in detail with reference to FIGS. 15A to 17B. FIG. 15A is a side view of the vicinity of the support leg portion 600 as viewed from the upstream side (R side) in the conveyance direction, and FIG. 15B is a section view of the vicinity of the support leg portion 600 as viewed from the downstream side (L side) in the conveyance direction. FIG. 16A is a side view of the vicinity of the support leg portion 600 as viewed from the R side in a state in which the saddle portion B2 has been drawn out, and FIG. 16B is a section view thereof. FIG. 17A is a perspective view of the support leg portion 600 as viewed from the upstream side (B side) in the draw-out direction of the saddle portion B2 in a state in which the saddle portion B2 has been drawn out, and FIG. 17B is a perspective view of the support leg portion 600 as viewed from the downstream side (F side) in the draw-out direction of the saddle portion B2 in a state in which the saddle portion B2 has been drawn out.

The support leg portion 600 is urged, by the spring 603 serving as an urging portion and a first urging portion, in a first direction in which the support leg portion 600 pivots from the accommodation position to the support position about the pivot shaft 602a in accordance with the operation of drawing out the saddle portion B2 from the housing 27. In addition, a restricting portion 610 restricts the pivoting of the support leg portion 600 in a second direction toward the accommodation position about the pivot shaft 602a until the saddle portion B2 reaches a predetermined position with respect to the housing 27 when the saddle portion B2 moves to the attached position in the housing 27 from the drawn-out state. In addition, the restricting portion 610 cancels the pivoting restriction of the support leg portion 600 in the second direction and allows the movement of the support leg portion 600 to the accommodation position, in accordance with the operation of inserting the saddle portion B2 into the housing 27 beyond the predetermined position with respect to the housing 27. Further, the spring 603 and the restricting portion 610 constitute a locking mechanism 620 that locks the support leg portion 600 at the support position in a state in which the saddle portion B2 has been drawn out from the sheet processing apparatus B. Detailed description will be given below.

The support leg portion 600 includes a support metal plate 602 supported to be pivotable about the pivot shaft 602a serving as a first pivot shaft with respect to a protruding plate portion 504d provided to protrude at a lower portion of the rail stay 504 or at a portion below the rail stay 504. Specifically, one end portion (upper end portion at the support position) of the support metal plate 602 is supported by the pivot shaft 602a. In contrast, the caster 601 is supported at the other end portion (lower end portion at the support position) of the support metal plate 602 to be rotatable about the rotation shaft 601a. The support metal plate 602 includes a first metal plate 605 serving as a first member and a second metal plate 606 serving as a second member. The first metal plate 605 is a metal plate member formed to have a C shape in section view and is supported to be pivotable about the pivot shaft 602a. The second metal plate 606 is a metal plate member formed to have a C shape in section view and is supported to be pivotable about the pivot shaft 602c serving as a second pivot shaft with respect to the first metal plate 605. A spring 607 serving as a second urging portion that urges the second metal plate 606 in a direction away from the first metal plate 605 is disposed between the first metal plate 605 and the second metal plate 606.

The spring 603 is a torsion coil spring having a coil portion supported by the pivot shaft 602a, a first-end-side portion 603a hooked on a cutout 504a (FIG. 17A) formed in the rail stay 504, and a second-end-side portion 603b hooked on a cutout 602b (FIG. 17B) formed in the support metal plate 602 as illustrated in FIGS. 15A, 16A, 17A, and 17B. The rail stay 504 includes a first plate portion 5041 disposed above the support metal plate 602, a second plate portion 5042 formed to have a shape extending from a B-side end portion of the first plate portion 5041 and bent downward, and third plate portions 5043 formed to have shapes extending from respective end portions of the first plate portion 5041 in the L-R direction and bent downward.

The cutout 504a is formed such that part of the second plate portion 5042 in the L-R direction is cut out downward from an upper end portion thereof. In addition, the cutout 504a is formed at a position above the pivot shaft 602a in the vertical direction, and the first-end-side portion 603a of the spring 603 is hooked on the cutout 504a at a position above the pivot shaft 602a in the vertical direction. To be noted, the protruding plate portion 504d described above is provided on the lower surface of the first plate portion 5041. In addition, the pair of third plate portions 5043 are respectively fixed to the slide rails 503b.

The support metal plate 602 is constituted by the first metal plate 605 and the second metal plate 606 each formed in a C shape in section view as described above. In the present embodiment, in a state in which the support leg portion 600 is at the support position, the first metal plate 605 is positioned on the F side of the second metal plate 606, and the second metal plate 606 is positioned in a space surrounded by the first metal plate 605. The cutout 602b is formed such that part of the F-side corner portion of the first metal plate 605 at the support position is cut out. The position where the second-end-side portion 603b of the spring 603 is hooked on the cutout 602b is above the pivot shaft 602a in the vertical direction at the accommodation position as illustrated in FIG. 15A, and is below the pivot shaft 602a in the vertical direction at the support position as illustrated in FIG. 16A. Further, as a result of the second-end-side portion 603b of the spring 603 being hooked on the cutout 602b at such a position and the first-end-side portion 603a being hooked on the cutout 504a at the position described above, the support metal plate 602 is urged by the spring 603 in a direction from the accommodation position toward the support position (counterclockwise direction in FIGS. 15A and 16A).

The spring 607 is a compression spring, and is disposed in a space surrounded by the first metal plate 605 and the second metal plate 606 each formed to in a C shape in section view. The spring 607 pushes the bottom surface of each metal plate in an elastically-compressed state, and thus an urging force in such a direction that the first metal plate 605 and the second metal plate 606 move away from each other is generated. To be noted, the position and shape of the spring 607 are not limited to these. The spring 607 does not have to be a compression spring as long as the urging force in such a direction that the first metal plate 605 and the second metal plate 606 move away from each other can be generated, and may be, for example, a torsion coil spring. In addition, the spring 607 may be disposed on the outside of the first metal plate 605 and the second metal plate 606.

In addition, the support metal plate 602 is provided with an abutting member 604. The abutting member 604 is fixed to a side surface of the second metal plate 606 on the side opposite to the side on which the first metal plate 605 is positioned. As illustrated in FIGS. 15A and 15B, when the support leg portion 600 is at the accommodation position, the abutting member 604 abuts the front lower stay 500a by the urging force of the spring 603. In addition, when the support leg portion 600 is at the accommodation position, the surface of the support leg portion 600 (side surface of the first metal plate 605) on the opposite side to the abutting member 604 abuts the first plate portion 5041 of the rail stay 504 by the urging force of the spring 607 between the first metal plate 605 and the second metal plate 606. That is, in a state in which the support leg portion 600 is at the accommodation position, the support metal plate 602 and the abutting member 604 extend between the rail stay 504 and the front lower stay 500a in a tense state by the urging force of the spring 603 and the spring 607. Therefore, unintended wobbling in a state in which the support leg portion 600 is at the accommodation position can be suppressed, and for example, occurrence of a noise caused by swing of the support leg portion 600 in the up-down direction during movement of the sheet processing apparatus B can be suppressed.

Further, as will be described in detail later, in the course of movement of the support leg portion 600 from the accommodation position to the support position, when the restriction by the abutment between the abutting member 604 and the front lower stay 500a is cancelled, the support leg portion 600 moves to the support position by the urging force of the spring 603. At this time, the second metal plate 606 pivots in a direction away from the first metal plate 605 by the urging force of the spring 607 provided between the first metal plate 605 and the second metal plate 606 constituting the support metal plate 602.

### Restriction of Support Leg Portion

Next, a configuration for restricting the pivoting of the support leg portion 600 will be described with reference to FIGS. 16B, 17A, and 18. The second metal plate 606 constituting the support metal plate 602 includes a bent portion 606a serving as a first engagement portion, and an abutting portion 606b as illustrated in FIG. 16B. The bent portion 606a is formed by bending the upper end portion of the second metal plate 606 at the support position to the B side. The abutting portion 606b is a portion positioned below the bent portion 606a on the B-side side surface of the second metal plate 606 at the support position. Meanwhile, a hole portion 504b serving as a second engagement portion is formed in the second plate portion 5042 of the rail stay 504. The hole portion 504b is a through hole extending in the F-B direction.

As described above, when the support leg portion 600 moves from the accommodation position to the support position and the second metal plate 606 pivots in a direction away from the first metal plate 605 by the urging force of the spring 607, the bent portion 606a of the second metal plate 606 is inserted into the hole portion 504b of the rail stay 504 as illustrated in FIG. 16B. At this time, the abutting portion 606b of the second metal plate 606 abuts an abutted portion 504c that is a portion of the F-side side surface of the second plate portion 5042 below the hole portion 504b at the support position. As a result of this, the pivoting of the support leg portion 600 urged toward the support position by the spring 603 is restricted, and the support leg portion 600 is positioned at the support position. That is, the abutting portion 606b of the second metal plate 606 and the abutted portion 504c of the second plate portion 5042 function as a restricting portion that restricts the pivoting of the support leg portion 600 in the first direction, and a state in which the abutting portion 606b is abutting the abutted portion 504c is a state in which the support leg portion 600 is at the support position.

At this time, the urging force of the spring 603 acts on the support metal plate 602 in a counterclockwise direction about the pivot shaft 602a as indicated by a circle D1 indicated by a broken line in FIG. 16B. Meanwhile, the urging force of the spring 607 acts between the first metal plate 605 and the second metal plate 606 constituting the support metal plate 602. Therefore, the urging force of the spring 607 acts on the second metal plate 606 in the clockwise direction about the pivot shaft 602c as indicated by a circle D2 indicated by a broken line in FIG. 16B. To be noted, in this state, the bent portion 606a of the second metal plate 606 is merely inserted in the hole portion 504b of the second plate portion 5042, and the bent portion 606a is not engaged with the hole portion 504b.

At a stage in which the support leg portion 600 has pivoted from the accommodation position by being urged by the spring 603 and the pivoting of the support leg portion 600 is restricted by the abutment between the abutting portion 606b and the abutted portion 504c, the caster 601 is not in contact with the installation surface α such as a floor on which the sheet processing apparatus B is installed as illustrated in FIG. 16A. That is, at a stage in which the saddle portion B2 has been drawn out from the housing 27 and which is immediately after the support leg portion 600 has pivoted from the accommodation position to the support position, a lowermost surface β of the caster 601 is away from the installation surface α. In other words, in the case where the distance between the pivot shaft 602a and the lowermost surface β of the caster 601 that is the lower end portion of the support leg portion 600 in the vertical direction is L1 and the distance between the pivot shaft 602a and the lower end portion (lowermost surface) of the caster 502 serving as a main support portion in the vertical direction is L2 in a state in which the support leg portion 600 is at the support position, L1<L2 is satisfied. In the present embodiment, in this state, the caster 601 is at a position where the lowermost surface β is 10 mm away from the installation surface α on which the casters 502 are installed.

This is because in the case where the caster 601 abuts the installation surface α while the support leg portion 600 moves from the accommodation position to the support position, the restriction by the abutment between the abutting portion 606b of the second metal plate 606 and the abutted portion 504c of the second plate portion 5042 does not act, and there is a possibility that the support leg portion 600 cannot be reliably positioned at the support position. In this case, there is a possibility that the bent portion 606a of the second metal plate 606 does not enter the hole portion 504b of the second plate portion 5042, and if the bent portion 606a has not entered the hole portion 504b, as will be described later, there is a possibility that, in the case where a force is applied to the support leg portion 600 in a second direction opposite to the first direction, the support leg portion 600 pivots in a direction to return to the accommodation position, and the saddle portion B2 ceases to be supported by the support leg portion 600.

Therefore, in the present embodiment, in the case where the support leg portion 600 pivots from the accommodation position to the support position in accordance with the draw-out operation of the saddle portion B2, the caster 601 of the support leg portion 600 does not abut the installation surface a until the abutting portion 606b abuts the abutted portion 504c. To be noted, in a state in which the saddle portion B2 has been further drawn out from the body frame 500 beyond a predetermined amount, the caster 601 of the support leg portion 600 is placed on the installation surface α as a result of the rail portion 503 warping due to the weight of the saddle portion B2. The predetermined amount is an amount of pivoting until the pivoting of the support leg portion 600 is restricted (pivoting amount from the accommodation position until the abutting portion 606b abuts the abutted portion 504c). That is, when the saddle portion B2 is drawn out by a predetermined amount, the pivoting of the support leg portion 600 is restricted, and when the saddle portion B2 is further drawn out from this position, the rail portion 503 warps due to the weight of the saddle portion B2, the caster 601 comes into contact with the installation surface α, and the saddle portion B2 is supported by the installation surface α via the support leg portion 600.

Here, for example, when returning the saddle portion B2 from the drawn-out position to the attached position in a state in which the caster 601 of the support leg portion 600 is placed on the installation surface, a force to pivot the support leg portion 600 in a clockwise direction in FIG. 16B, that is, in a second direction about the pivot shaft 602a acts on the support leg portion 600 due to the contact between the caster 601 and the installation surface. At this time, if the pivoting of the support leg portion 600 in the second direction is not restricted, there is a possibility that the support leg portion 600 pivots in a direction to return to the accommodation position, and the saddle portion B2 ceases to be supported by the support leg portion 600. Therefore, in the present embodiment, the restricting portion 610 that restricts movement of the caster 601 from the support position to the accommodation position in the case where the saddle portion B2 moves in a direction to be inserted into the sheet processing apparatus B from the drawn-out state is provided. In the present embodiment, the restricting portion 610 restricts the pivoting of the support leg portion 600 supporting the caster 601 in a second direction toward the accommodation position about the pivot shaft 602a.

The restricting portion 610 restricts the pivoting of the support leg portion 600 in the second direction toward the accommodation position about the pivot shaft 602a until the saddle portion B2 reaches a predetermined position in the housing 27 when inserting the saddle portion B2 into the housing 27 from the drawn-out state. The predetermined position is a position where the abutting member 604 abuts the front lower stay 500a of the body frame 500 when the saddle portion B2 moves from the drawn-out position to the attached position as will be described later.

The restricting portion 610 configured in this manner includes the bent portion 606a serving as the first engagement portion and the hole portion 504b serving as the second engagement portion described above. The hole portion 504b is provided in the rail stay 504 that is a member that moves together with the saddle portion B2 during the insertion and draw-out operation of the saddle portion B2 as described above. The hole portion 504b that the bent portion 606a engages with may be provided in a member different from the rail stay 504 as long as the member moves together with the saddle portion B2 during the insertion and draw-out operation of the saddle portion B2. Further, the hole portion 504b engages with the bent portion 606a and restricts pivoting of the support leg portion 600 in the case where the support leg portion 600 has pivoted in the second direction about the pivot shaft 602a, in a state in which the saddle portion B2 is positioned upstream of a predetermined position in the insertion direction of the saddle portion B2, that is, at a position before the abutting member 604 abuts the front lower stay 500a.

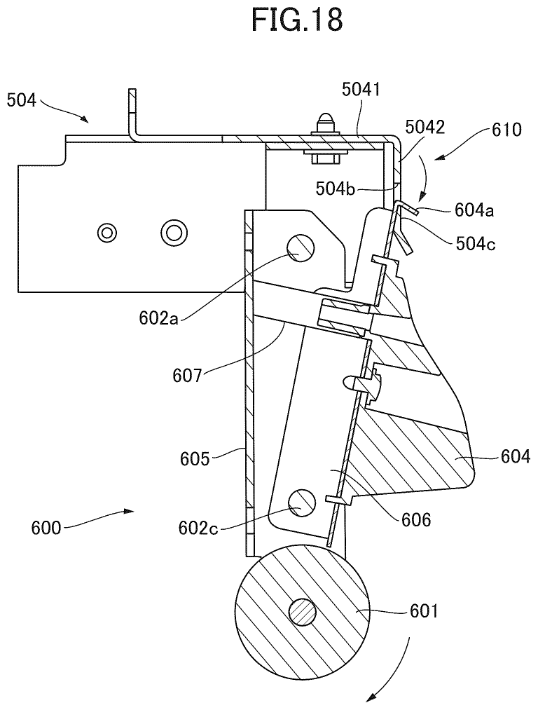

That is, when a force acts in such a direction that the support leg portion 600 pivots in the second direction about the pivot shaft 602a, the support leg portion 600 slightly pivots in the second direction about the pivot shaft 602a from the support position illustrated in FIG. 16B as illustrated in FIG. 18. At this time, the bent portion 606a inserted in the hole portion 504b is caught by the lower edge portion of the hole portion 504b, and thus further pivoting of the support leg portion 600 in the second direction is restricted. In this state, the support leg portion 600 has slightly pivoted in the second direction from the support position, and is capable of supporting the saddle portion B2 with respect to the installation surface. In addition, in this state, the support leg portion 600 is urged in the first direction by the spring 603, and therefore the support leg portion 600 is locked at the support position. Therefore, in the present embodiment, the restricting portion 610 and the spring 603 function as the locking mechanism 620 that locks the support leg portion 600 at the support position.

As described above, in the present embodiment, the support leg portion 600 can be reliably positioned at the support position when moving the saddle portion B2 from the attached position to the drawn-out position with respect to the body frame 500. In addition, when moving the saddle portion B2 from the drawn-out position to the attached position, a situation in which the support leg portion 600 pivots in the second direction to the predetermined position and the saddle portion B2 ceases to be supported by the support leg portion 600 can be suppressed. As a result of this, the support state of the saddle portion B2 by the support leg portion 600 can be more reliably maintained during the draw-out and insertion operation of the saddle portion B2. Therefore, a situation in which the sheet processing apparatus B falls to the front side in a state in which the saddle portion B2 has been drawn out can be suppressed.

To be noted, the caster 601 is configured not to abut the installation surface until the abutting portion 606b abuts the abutted portion 504c even in a state in which the distance between the installation surface and the bottom surface of the body frame 500 to which the four casters 502 are adjustably fixed to match the height of the image forming apparatus A with the height of the sheet processing apparatus B is the smallest.

### Cancellation of Restriction

Next, the configuration of the restriction cancellation of the restricting portion 610 will be described. In the present embodiment, as described above, the bent portion 606a engages with the hole portion 504b, and thus unintended pivoting of the support leg portion 600 from the support position to the accommodation position is suppressed. To be noted, when inserting the saddle portion B2 into the housing 27, the support leg portion 600 needs to be pivoted to the accommodation position. Therefore, in the present embodiment, the restricting portion 610 cancels the pivoting restriction of the support leg portion 600 in the second direction in accordance with an operation of inserting the saddle portion B2 into the housing 27 beyond a predetermined position with respect to the housing 27, and thus allows the movement of the support leg portion 600 to the accommodation position.

Therefore, in the present embodiment, the urging force of the spring 607 disposed between the first metal plate 605 and the second metal plate 606 constituting the support metal plate 602 is set to be lower than the urging force of the spring 603 urging the support leg portion 600 toward the support position. In addition, the bent portion 606a is formed to not engage with the hole portion 504b in the case where the second metal plate 606 has pivoted in a direction toward the first metal plate 605 about the pivot shaft 602c. That is, as illustrated in FIG. 16B, the bent portion 606a pivots in a direction along the trajectory of the circle D2 about the pivot shaft 602a. The direction along the trajectory of the circle D2 is a direction in which the second metal plate 606 pivots in a direction toward the first metal plate 605 about the pivot shaft 602c. The positional relationship of the bent portion 606a with the hole portion 504b and the bending angle of the bent portion 606a are defined such that the bent portion 606a does not come into contact with hole portion 504b in the case where the bent portion 606a pivots about the pivot shaft 602a in either of the case where the bent portion 606a pivots in the clockwise direction in the drawing and the case where the bent portion 606a pivots in the counterclockwise direction.

To be noted, as described above, in the case where the support leg portion 600 pivots in the clockwise direction of FIG. 16B, that is, the second direction about the pivot shaft 602a due to the contact between the caster 601 and the installation surface when returning the saddle portion B2 from the drawn-out position to the attached position, the caster 601 pivots along the trajectory of the circle D1. Then, the distal end portion of the bent portion 606a pivots in the clockwise direction from the position of FIG. 16B, and as illustrated in FIG. 18, engages with the hole portion 504b. That is, in the present embodiment, in the case where the support leg portion 600 pivots in the second direction about the pivot shaft 602a, the bent portion 606a engages with the hole portion 504b, and thus further pivoting of the support leg portion 600 toward the accommodation position is restricted, and in the case where the second metal plate 606 has pivoted about the pivot shaft 602c in a direction toward the first metal plate 605, the bent portion 606a does not engage with the hole portion 504b and is released from the hole portion 504b, and thus allows the pivoting of the support leg portion 600 in the second direction about the pivot shaft 602c.

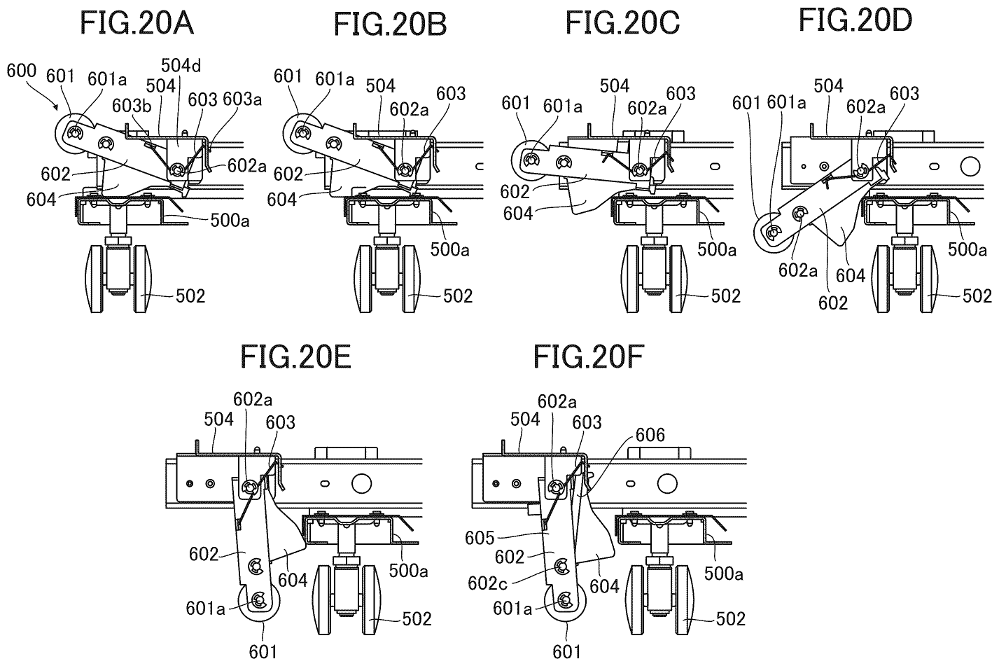

As described above, the support leg portion 600 is provided with the abutting member 604. The abutting member 604 is provided on the second metal plate 606, and abuts part of the housing 27 when the saddle portion B2 is inserted into the housing 27 from the drawn-out state and reaches the predetermined position. Specifically, in the course of transition from the state of FIG. 20F to the state of FIG. 20E that will be described later, the abutting member 604 abuts a surface on the F side of the front lower stay 500a of the body frame 500. Further, as illustrated in FIG. 20E, the abutting member 604 pivots the second metal plate 606 about the pivot shaft 602c in a direction toward the first metal plate 605 in accordance with the operation of inserting the saddle portion B2 into the housing 27 from the predetermined position.

That is, as a result of the abutting member 604 abutting the front lower stay 500a in accordance with the operation of inserting the saddle portion B2 into the housing 27, a force toward the first metal plate 605 acts on the second metal plate 606. As described above, the spring 607 disposed between the first metal plate 605 and the second metal plate 606 has a lower urging force than the spring 603 urging the support leg portion 600 toward the support position. Therefore, in the case where the force toward the first metal plate 605 acts on the second metal plate 606 as described above, first, the spring 607 is elastically compressed, and the second metal plate 606 moves closer to the first metal plate 605. At this time, since the spring 603 has a higher urging force than the spring 607, the pivoting about the pivot shaft 602c of the support leg portion 600 does not occur, and an operation of moving the second metal plate 606 closer to the first metal plate 605 is performed.

To be noted, if the spring 603 has a lower urging force than the spring 607, in the case where the force toward the first metal plate 605 acts on the second metal plate 606 as described above, first, there is a possibility that the spring 603 elastically deforms and the support leg portion 600 pivots in the second direction about the pivot shaft 602a. In this case, the bent portion 606a engages with the hole portion 504b, and the restriction by the restricting portion 610 is not cancelled. Therefore, in the present embodiment, the urging force of the spring 603 is set to be higher than the urging force of the spring 607. As a result of this, in the case where a force toward the first metal plate 605 acts on the second metal plate 606, the spring 607 elastically deforms before the spring 603 elastically deforms, such that the support leg portion 600 pivots about the pivot shaft 602c in such a direction that the second metal plate 606 moves closer to the first metal plate 605 before the support leg portion 600 pivots in the second direction about the pivot shaft 602a. As a result of this, the restriction by the restricting portion 610 can be reliably cancelled, and the support leg portion 600 can be pivoted from the support position to the accommodation position in accordance with the operation of inserting the saddle portion B2 into the housing 27.

In the present embodiment, to smoothly pivot the support leg portion 600 between the support position and the accommodation position in accordance with the insertion and draw-out operation of the saddle portion B2 as described above, the shape of the abutting member 604 is set such that the lower portion thereof has a larger thickness in the F-B direction than the upper portion thereof in a state in which the support leg portion 600 is at the support position. In addition, the abutting surface 604a of the abutting member 604 that abuts the front lower stay 500a that is a part of the housing 27 is formed to abut the front lower stay 500a when the saddle portion B2 is inserted into the housing 27 from the predetermined position, such that the support leg portion 600 pivots about the pivot shaft 602a and is accommodated in the accommodation position.

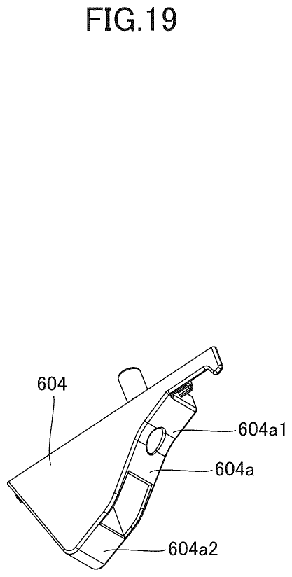

Specifically, the shape of the abutting surface 604a that abuts the front lower stay 500a of the abutting member 604 is set as a shape constituted by a plurality of curved surfaces. FIG. 19 is a perspective view of the abutting member 604 as viewed from the abutting surface 604a side. The abutting surface 604a includes a first region 604a1 and a second region 604a2. The first region 604a1 abuts an upper corner portion of the front lower stay 500a during the insertion and draw-out operation of the saddle portion B2, and the second region 604a2 abuts the upper surface of the front lower stay 500a in a state in which the support leg portion 600 is at the accommodation position and abuts or closely opposes the F-side surface of the front lower stay 500a when the support leg portion 600 has pivoted from the accommodation position and reaches the support position.

The shape of the first region 604a1 is set such that the abutting surface 604a mostly smoothly abuts the upper corner portion of the front lower stay 500a and does not get caught by the corner portion when the support leg portion 600 moves in the F-B direction together with the saddle portion B2. Specifically, the first region 604a1 has a curved shape which is recessed toward the second metal plate 606 side and in which a portion more on the F side is lower in a state in which the support leg portion 600 is at the accommodation position. As described above, the abutting surface 604a is configured to abut the corner portion of the front lower stay 500a when the support leg portion 600 moves in the F-B direction such that the pivoting of the support leg portion 600 between the accommodation position and the support position can be smoothly performed. The second region 604a2 is smoothly continuous with the first region 604a1 and is farther from the second metal plate 606 than the first region 604a1, and is formed as a flat surface or a convex surface with a small curvature that stably abuts the upper surface of the front lower stay 500a in a state in which the support leg portion 600 is at the accommodation position.

The pivot operation of the support leg portion 600 including the abutting member 604 configured in this manner in accordance with the draw-out operation of the saddle portion B2 will be described with reference to FIGS. 20A to 20F. FIG. 20A illustrates a state in which the saddle portion B2 is positioned at the attached position and the support leg portion 600 is positioned at the accommodation position. In this state, the second region 604a2 of the abutting member 604 abuts the upper surface of the front lower stay 500a by the urging force of the spring 603. When the saddle portion B2 is drawn out from the housing 27 from this state, the support leg portion 600 also moves to the F side as illustrated in FIG. 20B. In this state, the second region 604a2 of the abutting member 604 is still in contact with the upper surface of the front lower stay 500a.

Next, when the saddle portion B2 is further drawn out from the housing 27, as illustrated in FIG. 20C, the first region 604a1 of the abutting member 604 starts abutting the upper corner portion of the front lower stay 500a, and the support leg portion 600 starts pivoting in the first direction by the urging force of the spring 603. When the saddle portion B2 is further drawn out from the housing 27, as illustrated in FIG. 20D, the first region 604a1 of the abutting member 604 moves while sliding on the upper corner portion of the front lower stay 500a, and the support leg portion 600 further pivots in the first direction by the urging force of the spring 603.

When the saddle portion B2 is further drawn out from the state of FIG. 20D, as illustrated in FIG. 20E, the support leg portion 600 is released from the upper side of the front lower stay 500a and pivots further. At this time, the second region 604a2 of the abutting member 604 is abutting an F-side side surface of the front lower stay 500a, and the second metal plate 606 is moving closer to the first metal plate 605 against the urging force of the spring 607. Therefore, the abutting portion 606b of the second metal plate 606 is not abutting the abutted portion 504c of the rail stay 504.

When the saddle portion B2 is further drawn out from the state of FIG. 20E, the abutting member 604 is separated from the side surface of the front lower stay 500a, and the second metal plate 606 pivots about the pivot shaft 602c in a direction away from the first metal plate 605 by the urging force of the spring 607. Then, as illustrated in FIG. 16B described above, the abutting portion 606b abuts the abutted portion 504c, the pivoting of the support leg portion 600 in the first direction is restricted, and the support leg portion 600 is positioned at the support position. In addition, in this state, the bent portion 606a is inserted in the hole portion 504b. This state is a state in which the stopper of the support leg portion 600 is functioning.

In contrast, when inserting the saddle portion B2 from the drawn-out position to the attached position, the stopper of the support leg portion 600 described above functions until the state of FIG. 20F is reached. That is, the bent portion 606a is engaged with the hole portion 504b and pivoting of the support leg portion 600 in the second direction is suppressed even in the case where a force to pivot the support leg portion 600 in the second direction about the pivot shaft 602a is applied, until the abutting member 604 provided on the support leg portion 600 abuts the front lower stay 500a (until the saddle portion B2 reaches a predetermined position with respect to the housing 27). In the present embodiment, a position where the abutting member 604 abuts the F-side side surface of the front lower stay 500a is set as the predetermined position.

When the saddle portion B2 is further inserted from the state of FIG. 20F, the abutting member 604 abuts the F-side side surface of the front lower stay 500a, and thus the second metal plate 606 is pushed. Then, the second metal plate 606 pivots about the pivot shaft 602c in such a direction that the second metal plate 606 moves closer to the first metal plate 605 against the urging force of the spring 607, and as described above, the bent portion 606a is released from the hole portion 504b. That is, the stopper function of the support leg portion 600 is cancelled. As a result of this, it becomes possible for the support leg portion 600 to pivot in the second direction about the pivot shaft 602a. When the saddle portion B2 is further inserted into the housing 27 in this state, the support leg portion 600 pivots in the second direction about the pivot shaft 602a against the urging force of the spring 603 in the order of FIG. 20D, FIG. 20C, and FIG. 20B, and pivots to the accommodation position as illustrated in FIG. 20A, due to the abutment between the abutting member 604 and the upper corner portion of the front lower stay 500a.

As described above, in the present embodiment, further pivoting of the support leg portion 600 in the first direction (counterclockwise direction) is suppressed by the abutment between the abutting portion 606b and the abutted portion 504c even in the case where a force to pivot the support leg portion 600 in the first direction about the pivot shaft 602a is applied. That is, a situation in which the saddle portion B2 cannot be supported by the support leg portion 600 can be suppressed even when a load is applied to the support leg portion 600 when drawing out the saddle portion B2 from the inside of the housing 27.

In addition, when a force to pivot the support leg portion 600 in the second direction (clockwise direction) about the pivot shaft 602a is applied, the bent portion 606a engages with the hole portion 504b, and thus further pivoting of the support leg portion 600 in the second direction is suppressed. That is, a situation in which the saddle portion B2 cannot be supported by the support leg portion 600 can be suppressed even when a load is applied to the support leg portion 600 when inserting the saddle portion B2 into the housing 27. As described above, in the present embodiment, during the insertion and draw-out operation of the saddle portion B2, the support leg portion 600 is maintained at the support position, and a situation in which the saddle portion B2 cannot be supported by the support leg portion 600 can be suppressed, even in the case where, for example, a force in the first direction or the second direction is applied to the support leg portion 600 about the pivot shaft 602a due to the friction between the caster 601 and the installation surface or the like. To be noted, a configuration in which return of the support leg portion 600 to the accommodation position is restricted by manually activating the stopper function may be employed as long as the saddle portion B2 can be supported by the support leg portion 600 when drawing out and inserting the saddle portion B2 as described above.

In addition, as illustrated in FIG. 20E, the abutting member 604 abuts the F-side side surface of the front lower stay 500a during the insertion operation of the saddle portion B2, and thus the second metal plate 606 pivots to cancel the stopper function of the support leg portion 600. That is, the stopper function of the support leg portion 600 is automatically cancelled by the operation in which the user inserts the saddle portion B2 into the housing 27, and thus pivoting of the support leg portion 600 to the accommodation position is allowed. Therefore, a special operation for allowing the support leg portion 600 to pivot to the accommodation position, such as manually cancelling the stopper function is not needed, and thus the usability can be improved.

To be noted, in the present embodiment, as illustrated in FIG. 14A described above, the front lower stay 500a is subjected to a drawing process to secure strength, and the upper surface thereof is uneven. Therefore, the abutting member 604 of the support leg portion 600 can be caught by the uneven portion during the insertion and draw-out operation of the saddle portion B2. Therefore, a guide member 500a1 that guides the abutting member 604 such that the abutting member 604 is not caught is provided in a region of the front lower stay 500a that comes into contact with the abutting member 604. The guide member 500a1 may be omitted in the case where there is no portion that catches the abutting member 604 of the support leg portion 600 at the time of the insertion and draw-out operation of the saddle portion B2 such as a case where the surface of the front lower stay 500a is even. Although the guide member 500a1 has not been mentioned in the above description, the upper surface, F-side side surface, and upper corner portion of the front lower stay 500a that the abutting member 604 abuts serve as the upper surface, F-side side surface, and upper corner portion of the guide member 500a1.

### Another Example

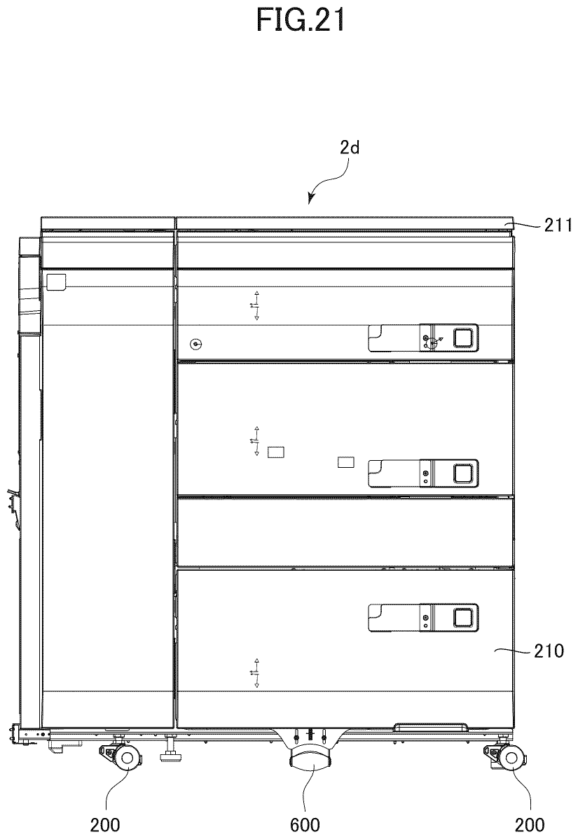

Although a configuration in which the support leg portion 600 is provided on the saddle portion B2 of the sheet processing apparatus B has been described above, the element in which the support leg portion 600 configured as described above is provided does not have to be the sheet processing apparatus B. For example, the support leg portion 600 may be provided on a lowermost cassette 210 of the sheet accommodating apparatus 2d as illustrated in FIG. 21. The sheet accommodating apparatus 2d has, for example, the configuration described with reference to FIG. 1.

The lowermost cassette 210 serving as an accommodation unit is provided to be capable of being drawn out from the housing 211 serving as a casing of the sheet accommodating apparatus 2d and inserted to an attached position in the housing 211, and accommodates sheets. Further, similarly to the case of the saddle portion B2 described above, the support leg portion 600 is configured to be supported by the cassette 210 during the insertion and draw-out operation of the cassette 210. The configuration including the stopper function of the support leg portion 600 and the like is the same as in the case described for the sheet processing apparatus B described above. In addition, the relationship between a plurality of casters 200 that support the sheet accommodating apparatus 2d with respect to the installation surface and the support leg portion 600 is the same as the relationship between the casters 502 and the support leg portion 600 described above.

As a result of supporting the cassette 210 by the support leg portion 600 during the insertion and draw-out operation of the lowermost cassette 210, inclination of the sheet accommodating apparatus 2d when drawing out the cassette 210 can be suppressed even in the case where, for example, a large amount of sheets are accommodated in the cassette 210 and the weight of the cassette 210 is large. In addition, by configuring the support leg portion 600 as described above, the support leg portion 600 can be maintained at the support position and a situation in which the cassette 210 cannot be supported by the support leg portion 600 can be suppressed during the insertion and draw-out operation of the cassette 210 even in the case where, for example, a force in the first direction or the second direction about the pivot shaft 602a acts on the support leg portion 600.

In addition, also in the case of the present embodiment, similarly to the first embodiment, the plurality of casters 200 include a plurality of unillustrated pivot shafts, and thus can turn with respect to the sheet accommodating apparatus 2d by 360° in addition to the rotation of the caster itself. This configuration is employed to facilitate handling of the apparatus when moving the sheet accommodating apparatus 2d to install the sheet accommodating apparatus 2d or the like. In contrast, the caster 601 provided on the support leg portion 600 is rotatable in only one direction (draw-out direction of the lowermost cassette 210).

As a result of this, since the caster 601 moves only in the same direction as the draw-out direction of the cassette 210 when drawing out the lowermost cassette 210, the load of operation by the user drawing out the cassette 210 is suppressed, leading to good operability. In other words, deterioration of operability caused by the caster 601 directing in a direction different from the draw-out direction when drawing-out the cassette 210 is suppressed.

Meanwhile, when moving the sheet accommodating apparatus 2d, in the case where the caster 601 of the support leg portion 600 is in contact with the installation surface when the casters 200 rotate and move in a direction different from the direction in which the sheet accommodating apparatus 2d moves by the rotation of the caster 601, it is difficult to move the sheet accommodating apparatus 2d because the caster 601 rotates in only one direction. In contrast, in the present embodiment, since the support leg portion 600 is positioned at the accommodation position, the caster 601 that rotates in only one direction of the support leg portion 600 does not interrupt the movement of the sheet accommodating apparatus 2d when moving the sheet accommodating apparatus 2d by the casters 200, therefore the sheet accommodating apparatus 2d can be smoothly moved, and the operability is good.

In addition, even if the caster 601 is configured to be capable of turning similarly to the casters 200, in the case where the installation surface such as a floor is uneven, there is a possibility that when moving the sheet accommodating apparatus 2d, the caster 601 abuts the uneven portion and thus interrupts the movement of the apparatus. To be noted, in the present embodiment, since the support leg portion 600 is configured to be movable from the support position to the accommodation position, deterioration of the usability can be suppressed without interrupting the movement of the apparatus itself.

### Other Embodiments

In the embodiment described above, the support leg portion 600 is configured to be moved to the support position and the accommodation position in an interlocked manner with the movement of the saddle portion B2 or the lowermost cassette 210 in the insertion direction and the draw-out direction. To be noted, the movement of the support leg portion 600 from the accommodation position to the support position may be performed manually as long as the support leg portion 600 is returned from the support position to the accommodation position in an interlocked manner with the movement of the saddle portion B2 or the lowermost cassette 210 in the insertion direction.

In addition, in the embodiment described above, a configuration in which the restricting portion 610 restricts movement (pivoting) of the support leg portion 600 in a direction from the support position toward the accommodation position and this restriction is cancelled in an interlocked manner with the movement of the saddle portion B2 or the lowermost cassette 210 in the insertion direction is employed. To be noted, for example, a configuration in which the support leg portion 600 is locked at the support position and this lock is manually released to return the support leg portion 600 to the accommodation position in an interlocked manner with the insertion of the saddle portion B2 or the lowermost cassette 210 may be employed.

In addition, in the embodiment described above, a case where the processing unit is a saddle portion B2 that performs a half-folding process, a saddle binding process, and a square back process as a predetermined process has been described. However, the processing unit is not limited to this, and may be a unit that performs one of these processes or a unit that performs a plurality of processes. In addition, the predetermined process is not limited to these processes, and may be an end binding process to be performed on an end portion of a sheet bundle, or a punching process of punching a hole in the sheet bundle. That is, it suffices as long as the predetermined process includes one or a plurality of processes among various processes that are conventionally known to be performed on a sheet or a sheet bundle, such as the half-folding process, the saddle binding process, the square back process, the end binding process, and the punching process.

In addition, although the sheet processing apparatus B includes a controller and the controller controls each element in the sheet processing apparatus in the embodiment described above, each element in the sheet processing apparatus B may be controlled by a controller included in the image forming apparatus.

Further, although a roller pair has been described as an example of a conveyance portion that conveys the sheet in the sheet processing apparatus B in the embodiment described above, the sheet may be conveyed by a belt. Specifically, any of a configuration in which the sheet is nipped and conveyed by a pair of belts, and a configuration in which the sheet is nipped and conveyed by a belt and a roller may be employed, and the configuration for conveyance may be changed in accordance with the position and path for conveyance of the sheet. For example, the sheet may be conveyed by a pair of rollers at a certain position and by a pair of belts at another position.

In addition, although the image forming system 1000 in which the sheet processing apparatus B is directly connected to the image forming apparatus A has been described in the embodiment described above, a different system configuration may be employed. For example, another processing apparatus, a conveyance apparatus, or the like may be connected between the image forming apparatus A and the sheet processing apparatus B. In addition, although the image forming apparatus A that forms a monochromatic image by using toner has been described as an example in the embodiment described above, an image forming apparatus that forms a color image by using toner may be used, or an image forming apparatus that forms an image on a sheet by using ink may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-222470, filed on Dec. 28, 2023, and Japanese Patent Application No. 2024-171115, filed on Sep. 30, 2024, which are hereby incorporated by reference herein in their entirety.

What is claimed is:

1. A sheet processing apparatus comprising:
a plurality of casters configured to movably support the sheet processing apparatus;
a processing unit provided to be capable of being drawn out from and inserted into the sheet processing apparatus and configured to perform a predetermined process on a sheet;
another caster provided in the processing unit and configured to come into contact with an installation surface and support the processing unit in a case where the processing unit moves in a draw-out direction, the installation surface being a surface on which the sheet processing apparatus is installed; and
a support portion configured to support the other caster such that the other caster is movable to an accommodation position and a support position and move the other caster from the support position to the accommodation position in accordance with an operation of inserting the processing unit, the accommodation position being a position where the other caster is positioned in a state in which the processing unit is inserted in the sheet processing apparatus, the support position being a position where the other caster supports the processing unit drawn out from the sheet processing apparatus with respect to the installation surface.

2. The sheet processing apparatus according to claim 1, wherein the support portion is configured to move the other caster from the accommodation position to the support position in accordance with an operation of drawing out the processing unit.

3. The sheet processing apparatus according to claim 1, further comprising a locking mechanism configured to lock the support portion at the support position in a state in which the processing unit has been drawn out from the sheet processing apparatus.

4. The sheet processing apparatus according to claim 1,
wherein the plurality of casters are provided on a bottom surface of the sheet processing apparatus, and
wherein the other caster and the support portion are positioned above the bottom surface at the accommodation position.

5. The sheet processing apparatus according to claim 1, further comprising a restricting portion configured to restrict movement of the other caster in a direction from the support position toward the accommodation position in a case where the processing unit moves in a direction in which the processing unit is inserted into the sheet processing apparatus from a drawn-out state.

6. The sheet processing apparatus according to claim 5, wherein the restricting portion is configured to cancel restriction of the support portion in the direction toward the accommodation position and allow the support portion to move to the accommodation position, in accordance with an operation of inserting the processing unit into the sheet processing apparatus.

7. The sheet processing apparatus according to claim 5, further comprising:
a first urging portion configured to urge the support portion in a direction from the accommodation position toward the support position; and
a first pivot shaft configured to pivotably support the support portion,
wherein the support portion includes a first member pivotably supported by the first pivot shaft, a second member supported to be pivotable about a second pivot shaft with respect to the first member, and a second urging portion configured to urge the second member in a direction away from the first member, and
wherein the restricting portion includes a first engagement portion provided on the second member, and a second engagement portion provided on a member that moves together with the processing unit in an insertion operation and a draw-out operation of the processing unit and configured to engage with the first engagement portion to restrict pivoting of the support portion in a case where the support portion pivots in a direction toward the accommodation position about the first pivot shaft.

8. The sheet processing apparatus according to claim 7, further comprising:
a rail portion configured to guide the processing unit such that the processing unit is capable of being drawn out from and inserted into the sheet processing apparatus; and
a rail-side support portion provided on the rail portion and configured to pivotably support the support portion about the first pivot shaft,
wherein the second engagement portion is formed on the rail-side support portion.

9. The sheet processing apparatus according to claim 7, wherein the second urging portion has a lower urging force than the first urging portion.

10. The sheet processing apparatus according to claim 9, wherein the first engagement portion does not engage with the second engagement portion in a case where the second member pivots in a direction toward the first member about the second pivot shaft.

11. The sheet processing apparatus according to claim 10, further comprising an abutting member provided on the second member and configured to, in a case where the processing unit is inserted into the sheet processing apparatus from the drawn-out state, abut part of the sheet processing apparatus and cause the second member to pivot in the direction toward the first member about the second pivot shaft in accordance with an operation of inserting the processing unit into the sheet processing apparatus.

12. The sheet processing apparatus according to claim 11, wherein an abutting surface of the abutting member configured to abut the part of the sheet processing apparatus is formed such that, in a case where the processing unit is inserted into the sheet processing apparatus, the abutting surface abuts the part of the sheet processing apparatus, and thus the support portion pivots about the first pivot shaft to be accommodated in the accommodation position.

13. The sheet processing apparatus according to claim 1, further comprising:
a pivot shaft configured to pivotably support the support portion; and
a main support portion configured to support the sheet processing apparatus with respect to the installation surface,
wherein L1<L2 is satisfied in a case where a distance in a vertical direction between the pivot shaft and a lower end portion of the support portion is LI and a distance in the vertical direction between the pivot shaft and a lower end portion of the main support portion is L2 in a state in which the support portion is at the support position.

14. The sheet processing apparatus according to claim 1,
wherein the processing unit includes
a conveyance portion configured to convey a sheet bundle subjected to a half-folding process or the sheet bundle subjected to a saddle binding process and the half-folding process such that a spine of the sheet bundle is positioned downstream of a fore edge of the sheet bundle in a conveyance direction in which the conveyance portion conveys the sheet bundle, and
a square back processing portion including a pair of nipping units and a pressing roller and configured to press, by the pressing roller, the spine of the sheet bundle nipped by the pair of nipping units such that the spine of the sheet bundle projects downstream with respect to the pair of nipping units in the conveyance direction, the pair of nipping units being configured to nip the sheet bundle and release the nipping of the sheet bundle by relatively moving with respect to the sheet bundle conveyed by the conveyance portion, the pressing roller being configured to press the spine of the sheet bundle nipped by the pair of nipping units toward the pair of nipping units, and
wherein the predetermined process includes the square back process.

15. An image forming system comprising:
an image forming unit including an image forming portion configured to form an image on a sheet; and
a sheet processing apparatus configured to perform a predetermined process on the sheet on which the image has been formed by the image forming portion,
wherein the sheet processing apparatus includes
a plurality of casters configured to movably support the sheet processing apparatus,
a processing unit provided to be capable of being drawn out from and inserted into the sheet processing apparatus and configured to perform the predetermined process on the sheet,
another caster provided in the processing unit and configured to come into contact with an installation surface and support the processing unit in a case where the processing unit moves in a draw-out direction, the installation surface being a surface on which the sheet processing apparatus is installed, and
a support portion configured to support the other caster such that the other caster is movable to an accommodation position and a support position and move the other caster from the support position to the accommodation position in accordance with an operation of inserting the processing unit, the accommodation position being a position where the other caster is positioned in a state in which the processing unit is inserted in the sheet processing apparatus, the support position being a position where the other caster supports the processing unit drawn out from the sheet processing apparatus with respect to the installation surface.

16. A sheet accommodating apparatus comprising:
a plurality of casters configured to movably support the sheet accommodating apparatus;
an accommodation unit provided to be capable of being drawn out from and inserted into the sheet accommodating apparatus and configured to accommodate a sheet;
another caster provided in the accommodation unit and configured to come into contact with an installation surface and support the accommodation unit in a case where the accommodation unit moves in a draw-out direction, the installation surface being a surface on which the sheet accommodating apparatus is installed; and
a support portion configured to support the other caster such that the other caster is movable to an accommodation position and a support position and move the other caster from the support position to the accommodation position in accordance with an operation of inserting the accommodation unit, the accommodation position being a position where the other caster is positioned in a state in which the accommodation unit is inserted in the sheet accommodating apparatus, the support position being a position where the other caster supports the accommodation unit drawn out from the sheet accommodating apparatus with respect to the installation surface.

17. The sheet accommodating apparatus according to claim 16, wherein the support portion is configured to move the other caster from the accommodation position to the support position in accordance with an operation of drawing out the accommodation unit.

18. The sheet accommodating apparatus according to claim 16, further comprising a locking mechanism configured to lock the support portion at the support position in a state in which the accommodation unit has been drawn out from the sheet accommodating apparatus.

19. The sheet accommodating apparatus according to claim 16,
wherein the plurality of casters are provided on a bottom surface of the sheet accommodating apparatus, and
wherein the other caster and the support portion are positioned above the bottom surface at the accommodation position.

20. The sheet accommodating apparatus according to claim 16, further comprising a restricting portion configured to restrict movement of the other caster in a direction from the support position toward the accommodation position in a case where the accommodation unit moves in a direction in which the accommodation unit is inserted into the sheet accommodating apparatus from a drawn-out state.

21. The sheet accommodating apparatus according to claim 20, wherein the restricting portion is configured to cancel restriction of the support portion in the direction toward the accommodation position and allow the support portion to move to the accommodation position, in accordance with an operation of inserting the accommodation unit into the sheet accommodating apparatus.

22. The sheet accommodating apparatus according to claim 20, further comprising:
a first urging portion configured to urge the support portion in a direction from the accommodation position toward the support position; and
a first pivot shaft configured to pivotably support the support portion,
wherein the support portion includes a first member pivotably supported by the first pivot shaft, a second member supported to be pivotable about a second pivot shaft with respect to the first member, and a second urging portion configured to urge the second member in a direction away from the first member, and
wherein the restricting portion includes a first engagement portion provided on the second member, and a second engagement portion provided on a member that moves together with the accommodation unit in an insertion operation and a draw-out operation of the accommodation unit and configured to engage with the first engagement portion to restrict pivoting of the support portion in a case where the support portion pivots in a direction toward the accommodation position about the first pivot shaft.

23. The sheet accommodating apparatus according to claim 22, further comprising:
a rail portion configured to guide the accommodation unit such that the accommodation unit is capable of being drawn out from and inserted into the sheet accommodating apparatus; and
a rail-side support portion provided on the rail portion and configured to pivotably support the support portion about the first pivot shaft,
wherein the second engagement portion is formed on the rail-side support portion.

24. The sheet accommodating apparatus according to claim 22, wherein the second urging portion has a lower urging force than the first urging portion.

25. The sheet accommodating apparatus according to claim 24, wherein the first engagement portion does not engage with the second engagement portion in a case where the second member pivots in the direction toward the first member about the second pivot shaft.

26. The sheet accommodating apparatus according to claim 25, further comprising an abutting member provided on the second member and configured to, in a case where the accommodation unit is inserted into the sheet accommodating apparatus from the drawn-out state, abut part of the sheet accommodating apparatus and cause the second member to pivot in the direction toward the first member about the second pivot shaft in accordance with an operation of inserting the accommodation unit into the sheet accommodating apparatus.

27. The sheet accommodating apparatus according to claim 26, wherein an abutting surface of the abutting member configured to abut the part of the sheet accommodating apparatus is formed such that, in a case where the accommodation unit is inserted into the sheet accommodating apparatus, the abutting surface abuts the part of the sheet accommodating apparatus, and thus the support portion pivots about the first pivot shaft to be accommodated in the accommodation position.

28. The sheet accommodating apparatus according to claim 16, further comprising:
a pivot shaft configured to pivotably support the support portion; and
a main support portion configured to support the sheet accommodating apparatus with respect to the installation surface,
wherein L1<L2 is satisfied in a case where a distance in a vertical direction between the pivot shaft and a lower end portion of the support portion is LI and a distance in the vertical direction between the pivot shaft and a lower end portion of the main support portion is L2 in a state in which the support portion is at the support position.

29. An image forming system comprising:
a sheet accommodating apparatus configured to accommodate a sheet; and
an image forming unit including an image forming portion configured to form an image on the sheet fed by the sheet accommodating apparatus,
wherein the sheet accommodating apparatus includes
a plurality of casters configured to movably support the sheet accommodating apparatus,
an accommodation unit provided to be capable of being drawn out from and inserted into the sheet accommodating apparatus and configured to accommodate the sheet,
another caster provided in the accommodation unit and configured to come into contact with an installation surface and support the accommodation unit in a case where the accommodation unit moves in a draw-out direction, the installation surface being a surface on which the sheet accommodating apparatus is installed, and
a support portion configured to support the other caster such that the other caster is movable to an accommodation position and a support position and move the other caster from the support position to the accommodation position in accordance with an operation of inserting the accommodation unit, the accommodation position being a position where the other caster is positioned in a state in which the accommodation unit is inserted in the sheet accommodating apparatus, the support position being a position where the other caster supports the accommodation unit drawn out from the sheet accommodating apparatus with respect to the installation surface.
